(19) United States
(12) Patent Application Publication
(10) Pub. No.: US 2016/0200437 A1
(43) Pub. Date: Jul. 14, 2016

(54) Tethered Flight Control System for Small Unmanned Aircraft

(71) Applicants: Mark Andrew Ryan, Lewes, DE (US); Kyle Mark Ryan, Lewes, DE (US)

(72) Inventors: Mark Andrew Ryan, Lewes, DE (US); Kyle Mark Ryan, Lewes, DE (US)

(21) Appl. No.: 14/993,681

(22) Filed: Jan. 12, 2016

Related U.S. Application Data
(60) Provisional application No. 62/102,283, filed on Jan. 12, 2015.
(60) Provisional application No. 62/116,125, filed on Feb. 13, 2015.
(60) Provisional application No. 62/191,041, filed on Jul. 10, 2015.

(51) Int. Cl. B64C 39/02; B64C 27/00; B64C 27/08; B64F 3/00; B64F 1/00

(52) U.S. Cl. CPC B64C 39/022; B64C 39/024; B64F 3/00; B64F 1/00; B64C 27/08; B64C 27/006; B64C 2201/024; B64C 2201/108; B64C 2201/086; B64C 2201/148

(57) ABSTRACT

A tethered flight control system for a small unmanned aircraft. The tethered flight control system can have a mobile base, a tether arm, a tether spout, and a remote-controlled winch that can hold a tether line, which can be connected to a small unmanned aircraft. By controlling the tether line using the winch, the small unmanned aircraft can be prevented from flying out of range or out of control. The winch can have a high-speed motor configured to remove substantially all slack from the tether line while the small unmanned aircraft is in flight. The winch can be controlled from a hard-wired winch remote, which can take the form of a foot pedal device having one or more foot pedals. The tether line can be attached to the small unmanned aircraft through a tether attachment apparatus, which can have a travel bar, two or more rotor protectors, and a mounting section.

### RELATED APPLICATIONS

This application claims the benefit of U.S. Provisional Application Nos. 62/102,283, 62/116,125, and 62/191,041, filed Jan. 12, 2015, Feb. 13, 2015, and Jul. 10, 2015, respectively, each of which is hereby incorporated herein in its entirety.

### TECHNOLOGY FIELD

The present application relates generally to a flight control system for a small unmanned aircraft having one or more rotors through the use of a tether, as well as an aerial media system and method for acquiring and communicating images using a tethered small unmanned aircraft.

### BACKGROUND

Small unmanned aircraft (SUA), colloquially referred to as drones, are used for a variety of purposes, including recreational, commercial, and public purposes. The Federal Aviation Administration (FAA) is working to keep up with the advances of SUA, and their increased popularity and availability.

The FAA is promulgating rules to facilitate the safe, responsible use of unmanned aircraft systems. The FAA defines an unmanned aircraft system as an unmanned aircraft and its associated elements related to safe operations, which may include control stations (ground, ship, or air-based), control links, support equipment, payloads, flight termination systems, and launch/recovery equipment. For example, it can include at least the following three elements: unmanned aircraft, control station, and data link. SUA can include airplanes, copters, and other aircraft.

SUA are subject to rules and regulations promulgated by the FAA including limitations with respect to altitude, time of day, line of sight, weight, and distance, as well as operator and aircraft registration and certification. Another issue the FAA is having difficulty with is identifying the operator of a SUA, important in cases of accidents or other incidents, as well as for security.

Many of these issues and concerns can be addressed through the use of a tether coupling the SUA to the ground, base, or other firm location (building, car, train, ship, bridge, etc.). Disclosed herein are tether and control systems, apparatus, and methods addressing at least some of these issues and concerns.

### SUMMARY

Embodiments can provide a tethered flight control system for a small unmanned aircraft which can comprise a mobile base, a tether arm extending radially from a fixation mechanism mounted to said base, a tether spout attached to the tether arm and capable of rotating 360 degrees, a winch having a reel for holding a tether line having an end and a winch motor configured to reel in the tether line, where the winch can be configured to be controlled by a winch remote, wherein the end of tether line can attach to the small unmanned aircraft via a tether attachment apparatus, and wherein the winch, tether arm, and tether spout can be aligned such that radial movement of the tether line causes rotation of the tether arm, tether arm, and tether spout to maintain alignment of these components with the tether line and the aircraft. In an embodiment, the winch remote can be configured to control one or more winch functions using one or more foot pedals.

In an embodiment, the winch can also have an additional high-speed motor which can be configured to reel in the tether line at a faster rate than the winch. The high-speed motor can be further configured to retrieve substantially all slack in the tether line while the small unmanned aircraft is in flight. In an embodiment, the winch can also have a drag lever configured to control the rate at which the winch allows the tether line to be unreeled. The drag level can be automated by servomotors which can be controlled by the winch remote.

In an embodiment, the tether arm can be mounted to the mobile base using a trailer hitch. In an embodiment, the mobile base can have a landing cover.

In an embodiment, the tether spout can have one or more sets of rollers, with each set having an upper roller and lower roller, wherein the tether line is configured to thread through the upper roller and lower roller. In an embodiment, the tether spout can also have a pivot configured to track the vertical movement of the small unmanned aircraft while in flight.

Embodiments can provide a tethered flight control system for a small unmanned aircraft that can comprise a stationary base comprising a base plate, a vertical stand, and a takeoff and landing platform; a winch, having a reel for holding a tether line having an end and a winch motor configured to reel in the tether line, the winch can be configured to be controlled by a winch remote; wherein the end of tether line can attach to the small unmanned aircraft; and wherein the small unmanned aircraft can be configured to rest on the takeoff and landing platform when not in flight.

In an embodiment, the stationary base can also have an extension pole configured to raise and lower the takeoff and landing platform. In an embodiment, the stationary base can also have a tether guide that can be configured to be inserted into the center of and through the takeoff and landing platform, wherein the tether line can feed though the tether guide.

In an embodiment, the takeoff and landing platform can have one or more areas of ferromagnetic material that can be configured to adhere the small unmanned aircraft to the takeoff and landing platform by magnetic force when not in flight.

In an embodiment, the takeoff and landing platform can have one or more areas of conductive material that can be configured to provide power to the small unmanned aircraft when not in flight.

Embodiments can provide a tether attachment apparatus for use in a tethered flight control system for a small unmanned aircraft having one or more rotors, which can have a mounting portion that can be configured to attach to a frame of the small unmanned aircraft; a travel bar that can be configured to have a tether line attach; and two or more rotor protectors that can be configured to prevent the tether line from striking the one or more rotors; wherein the travel bar can be mounted to the mounting portion such that the small unmanned aircraft has a full range of vertical and horizontal movement.

In an embodiment, the travel bar can be triangular, and can have an upper portion and a lowest point; wherein the lowest point can be mounted close to the central axis of the small unmanned aircraft, allowing the tether line to guide the small unmanned aircraft directly in a vertical direction; and wherein the upper portion is configured to align itself closest to the horizontal direction when the tether line is taut. In an alternate embodiment, the travel bar can be curvilinear.

In an embodiment, the apparatus can have a support arm mounted between the one or more rotor protectors. In an embodiment, the rotor protectors can be shaped as quarter circles.

### BRIEF DESCRIPTION OF THE DRAWING FIGURES

FIG. 1 is a perspective view of an exemplary small unmanned aircraft (SUA) tethered flight control system, in accordance with embodiments disclosed herein;

FIG. 2 is a partial side view of the exemplary tethered flight control system in some embodiments;

FIG. 3 is a perspective view of a tether spout for use in the tethered flight control system in some embodiments;

FIG. 4 is a perspective view of an alternate embodiment of a tether spout for use in the tethered flight control system in some embodiments;

FIG. 5 is a front view of a winch system for use in the tethered flight control system in some embodiments;

FIG. 6 is a side view of a small unmanned aircraft (SUA) with a tether attachment apparatus for use in the tethered flight control system in some embodiments;

FIG. 7 is a front view of a small unmanned aircraft (SUA) with a tether attachment apparatus for use in the tethered flight control system in some embodiments;

FIG. 8 is a perspective view of a small unmanned aircraft (SUA) with an alternate embodiment tether attachment apparatus for use in the tethered flight control system in some embodiments;

FIG. 9 is a perspective view of a small unmanned aircraft (SUA) with an alternate embodiment tether attachment apparatus for use in the tethered flight control system in some embodiments;

FIG. 10 is a side view of an exemplary stationary base for use with the tethered flight control system in accordance with some embodiments;

FIG. 11 is a perspective view of the takeoff and landing platform of the exemplary stationary base as shown in FIG. 10;

FIG. 12 is a side view of a small unmanned aircraft parked on the exemplary stationary base as shown in FIG. 10;

FIG. 13 is a perspective view of the tether attachment apparatus for use in the tethered flight control system in some embodiments;

FIG. 14 is a block diagram illustrating the components of the exemplary tethered flight control system as shown in FIG. 1;

FIG. 15 is a block diagram illustrating sample components of a small unmanned aircraft for use with the exemplary tethered flight control system in some embodiments;

FIG. 16 is a system diagram illustrating an exemplary aerial media system in accordance with embodiments described herein;

FIG. 17 is a system flow diagram illustrating an exemplary method of acquiring and providing news data in an exemplary aerial media system according to embodiments described herein;

FIG. 18 is a block diagram illustrating sample steps in an exemplary method of use for an aerial media system utilizing the tethered flight control system in some embodiments;

FIG. 19 is a flow diagram illustrating an exemplary method of implementing an expert nomination platform;

FIG. 20 is a flow diagram illustrating an exemplary method of implementing a news re-reporting platform;

FIG. 21 is a flow diagram illustrating an exemplary method of implementing an on-demand platform; and

FIG. 22 illustrates an example of a computing environment 2200 within which embodiments of the invention may be implemented.

### DETAILED DESCRIPTION

As will be readily understood, the systems and apparatus described herein at its most basic include a small unmanned aircraft (SUA), a tether line, and a base. The base can be permanent or temporary, it can be stationary or mobile, and it can be incorporated into a building, vehicle, sign, lamppost or other structure.

It is important to understand what is accomplished via the tether and the apparatus, systems, and methods described herein. One concern identified by the FAA is the identity or source of the SUA operator or owner. A tethered flight control system, particularly when pennants or flags are attached to the tether line, provides a direct and visual link, and thus accountability, to the operator of the system. As described below, the tethered flight control system also permits the implementation of physical limits on the aircraft's altitude, range, speed, or combinations thereof.

The tethered flight control system also provides several safety functions, including, but not limited to, hard stops, emergency retrieval, non-emergency retrieval, control over a rogue aircraft, line slack take-up, or combinations of these and other important safety features. Through experimentation, it has been found that through implementation of the apparatus, systems, and methods described herein, a SUA can be retrieved consistently and seamlessly from well beyond the current FAA limitations, and certainly within them. FAA limitations are tied to a line-of-sight visual contact requirement. While the FAA is of the belief that unaided human vision is limited to 2500 feet, an aircraft can be retrieved from at least 2100 feet away, and may reach a full range of more than 5,000 feet using the tethered flight control system described herein.

A tether line can be provided between the aircraft and a control station, in addition to any existing on-board controls (e.g. GPS control) and remote control (wired control, or wireless control through protocols such as radio, cellular, Wi-Fi, Bluetooth, etc.) In some embodiments, the tether line itself may also provide a hard-wired data link to the SUA. The use of the tether line can allow the operator to nearly instantly stop the aircraft. This can be done by applying a manual stop to prevent any further unreeling of tether line, or, where a more subtle stop is required, by slowing the release of tether line. This can be accomplished by controlling the spin rate of the reel via a mechanical brake or a tensioning system.

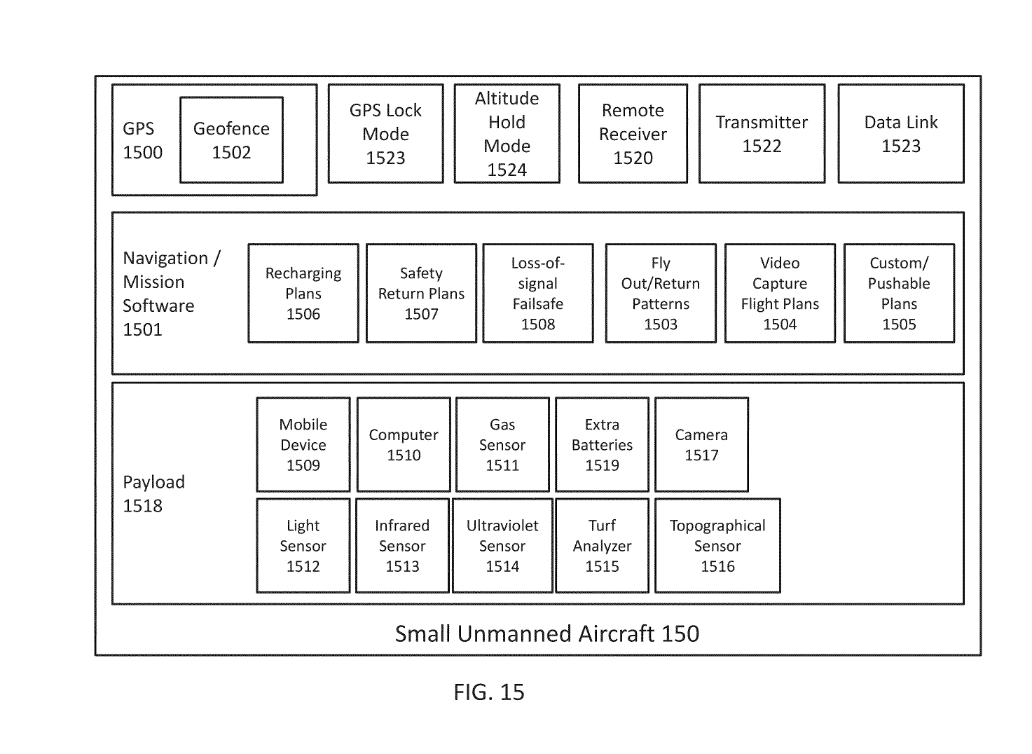

Referring to FIG. 15, with respect to retrieval, SUA 150 of many varieties do not respond well to being pulled, particularly when in a “GPS lock” mode 1523, which instructs the SUA 150 to maintain its left/right and front/back position. In “GPS lock” mode 1523, when the aircraft is pushed, its sensors and software kick in the rotors to maintain the original position. This creates a struggle between the aircraft and the tether often leading to a nosedive or other undesirable situation. Experimentation has found that when an SUA is put in an “altitude hold” mode 1524 (which merely restricts the SUA movement in an up and down plane) and pulled via the tethered flight control system described herein, the aircraft responds more akin to when it is pushed by wind, and thus responds more favorably to the pull of the tether line. In this mode, the aircraft is allowed free lateral movement while it maintains altitude. The result is that as the tether is reeled in the aircraft maintains tension by attempting to maintain altitude. The freedom of movement in the lateral directions allows the aircraft to maintain the right temperament to simply be pulled in as desired by the operator. The aircraft can be retrieved at any angle with respect to the tethered flight control system.

The on-board GPS 1500, and navigation and mission software 1501 varies from SUA to SUA, but many have similar features, including a geofence 1502, which can be used to limit the aircraft's flight area, including, but not limited to, flight ceiling, floor, and field (the plan view setting out geographic limits such as length and width, radius, or even more complex shapes). The geofence 1502 area may be limited in predetermined manner, for example to account for FAA-imposed limitations such as height above ground level. The use of software can allow for adjustment due to changes in laws or when necessitated by the location of the SUA and is relatively easy to fix via programming or user input.

The SUA may include mission software 1501 configured for automated flight patterns, including fly out and/or return patterns 1503, video capture flight plans 1504, custom/pushable plans 1505 (e.g., sent in real time via a remote), recharging plans 1506 (e.g., plan to return and/or recharge every time interval), and safety return flight plans 1507. Safety return plans 1507 can be activated should the aircraft malfunction or encounter trouble while in flight. The SUA may be configured to have a wireless loss-of-signal failsafe 1508 which returns the SUA to its base in the event the wireless control signal is lost, which can occur through a loss of power to the SUA remote or by the SUA flying out of range of the SUA remote.

The SUA may include any desired payload 1518 including an electronic device configured to collect, transmit, receive and display data (e.g., video, images and audio). Examples of electronic devices include any mobile device 1509 (e.g., smart phone, personal digital assistant (PDA), a tablet computer) and may also include a personal computer 1510 (laptop or desktop) or a networked computer. A variety of sensors may be carried as payload. For example, sensors may include gas sensors 1511, light sensors 1512, infrared (IR) sensors 1513, ultraviolet (UV) sensors 1514, turf analyzers 1515, or topographical sensors 1516. In essence, any device that can be carried by the SUA can be attached and can benefit from the systems and methods described herein.

Embodiments may include other types of SUA, such as helicopters, quadcopters, and other multi-rotor copters. Embodiments may include any type of camera 1517. The SUA may include extra batteries 1519, which may be recharged or changed. Range may be defined as any distance traveled on a single charge. The SUA remote 1520, which can control the various functions of the SUA, may be a handheld manual controller or a chip-driven/autonomous controller. The camera 1517 may include streaming encoding and transcoding capabilities. In some embodiments, the camera may be a GoPro™ camera with Wi-Fi capability. The camera 1517 may be a digital single lens reflex (DSLR) camera and may include a lens, plus accessories and 4k or higher streaming capability. The SUA may include a video processor/capture/transmitter unit 1522 with built-in Wi-Fi and may include transcoding/compression conversion software from captured video to streaming video. The SUA may also include a cellular datacenter data link 1523 and may have a bandwidth for providing HD video quality (e.g., 720p/1080p/4k).

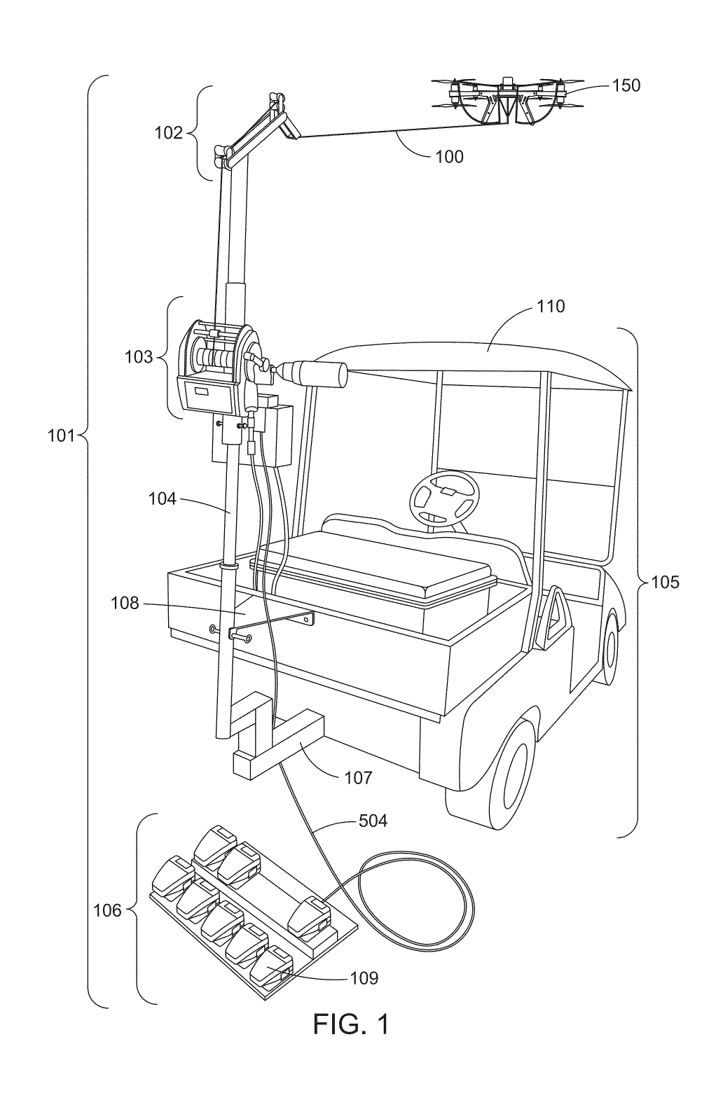

FIG. 1 is a perspective view of an exemplary small unmanned aircraft (SUA) tethered flight control system, in accordance with embodiments disclosed herein. In the present embodiment, the tethered flight control system 101 can have a tether arm 104 having a winch 103 holding a tether line 100, where the tether arm 104 can be mounted to a mobile base 105 through the use of a fixation mechanism 107, such as a standard trailer hitch.

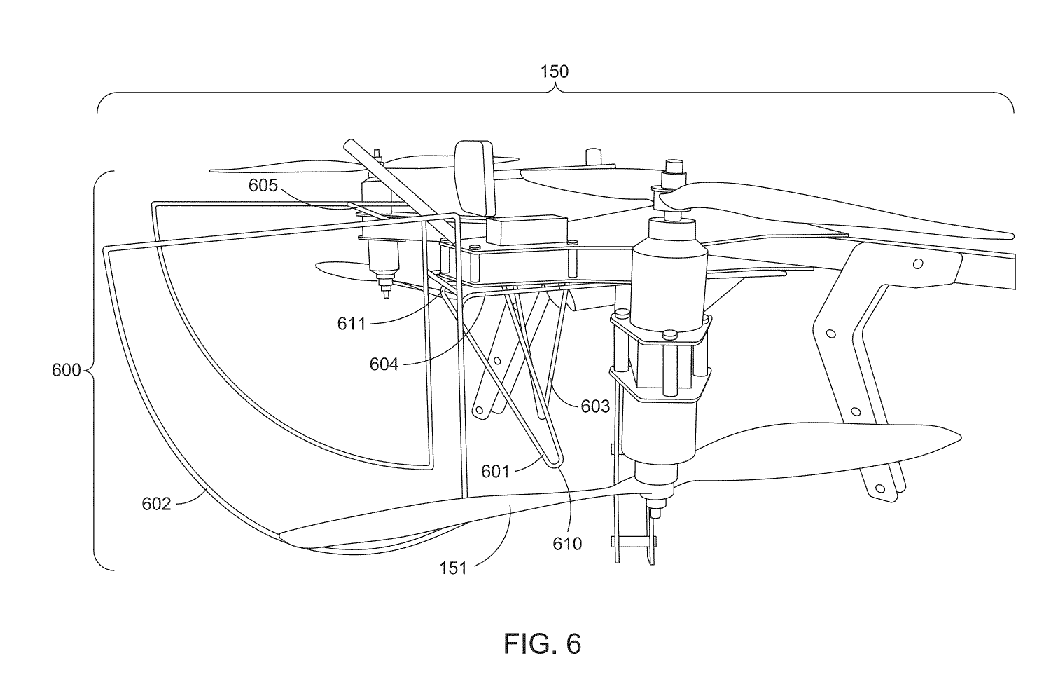

Any suitable line material may be used as the tether line 100, which can include, but is not limited to, metal, filament, twine, polymer, or composite material. A line material of sufficient strength to minimize or prevent breakage can be determined for each SUA based on the SUA's characteristics. Factors to consider can include the weight of the line material, the SUA frame shape, the flight speed required, the travel distance required, the pulling strength of the SUA, and the friction in the winch 103, tether arm 104, and tether spout 102. It also must be contemplated how the tether line 100 is coupled to the tether attachment apparatus (as described in FIG. 6-9) connecting the SUA 150 to the tether line 100. Although any suitable attachment method may be used, including a swivel or a clasp, an effective and simple method for attachment is a knot. Multiple tether lines and coupling methods can be used to build redundancies into the tethered flight control system. Although in most instances the SUA 150 will operate wirelessly and the tether line 100 is used for connection purposes, in some embodiments the tether line 100 itself may be or may include a wire or cable for transmitting data, control signals, electrical power, or a combination thereof between the mobile base 105 and the SUA 150.

The tether line 100 can originate at the reel of the winch 103, pass over (or through or along) the tether arm 104 and over (or through or along) the tether spout 102 to the tether attachment mechanism (as described in FIGS. 6-9) attaching the tether line 100 to the SUA 150. The tether arm 104 and tether spout 102 can be aligned with the winch 103, such that the tether arm 104, tether spout 102, winch 103, and tether line 100 can all be aligned regardless of the position of the SUA 150.

The winch 103 can be controlled by a winch remote 106, which can be hard-wired to the winch 103 through a winch control wire 504. One advantage of a hard-wired remote is it can allow flight in radio-dense environments and can avoid interference from foreign sources. A hard-wired remote can avoid a potential loss of control due to interference during critical safety retrieval operations. Alternatively, the winch remote 106 can be wireless. The winch remote 106 can be of a size and shape conducive to being hand-held. However, given that the SUA 150 can have its own handheld remote (not shown), which typically requires both hands of an operator, a second hand-held remote could become cumbersome or require two operators. Accordingly, FIG. 1 illustrates an embodiment of the winch remote 106 as a pedal system whereby a single operator can control the winch 103 by foot through a series of pedals 109 while manipulating the SUA remote with his or her hands. The winch remote 106 can be mounted on or inside the mobile base 105, or can be placed exterior to the mobile base at a range dictated by the winch control wire 504 length. In an alternate embodiment, the functionality of winch remote 106 can be duplicated or replaced by one or more electronic control buttons, which can be mounted, for example, on the steering device of the mobile base 105.

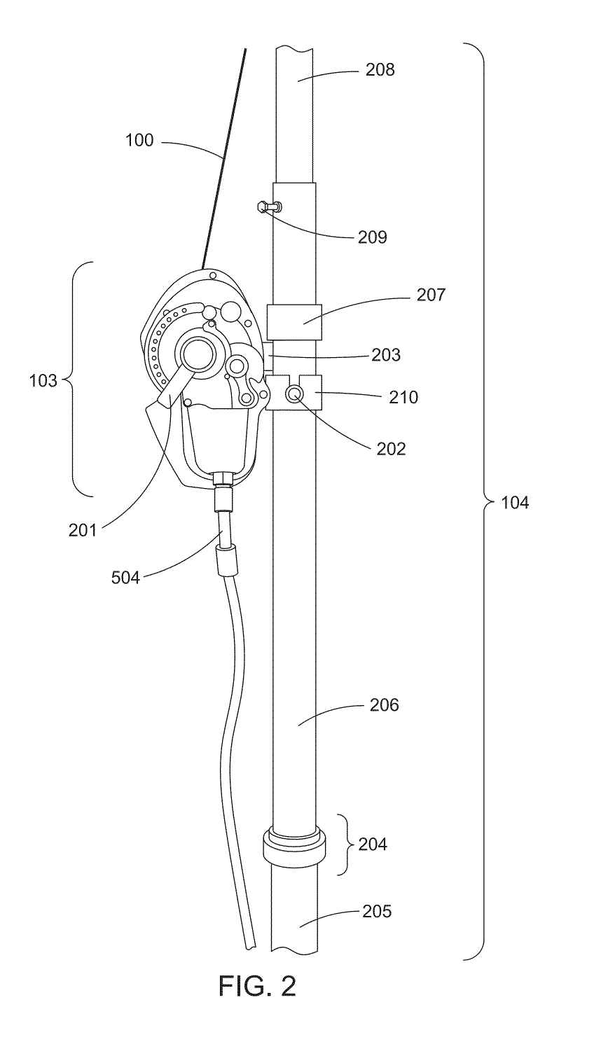

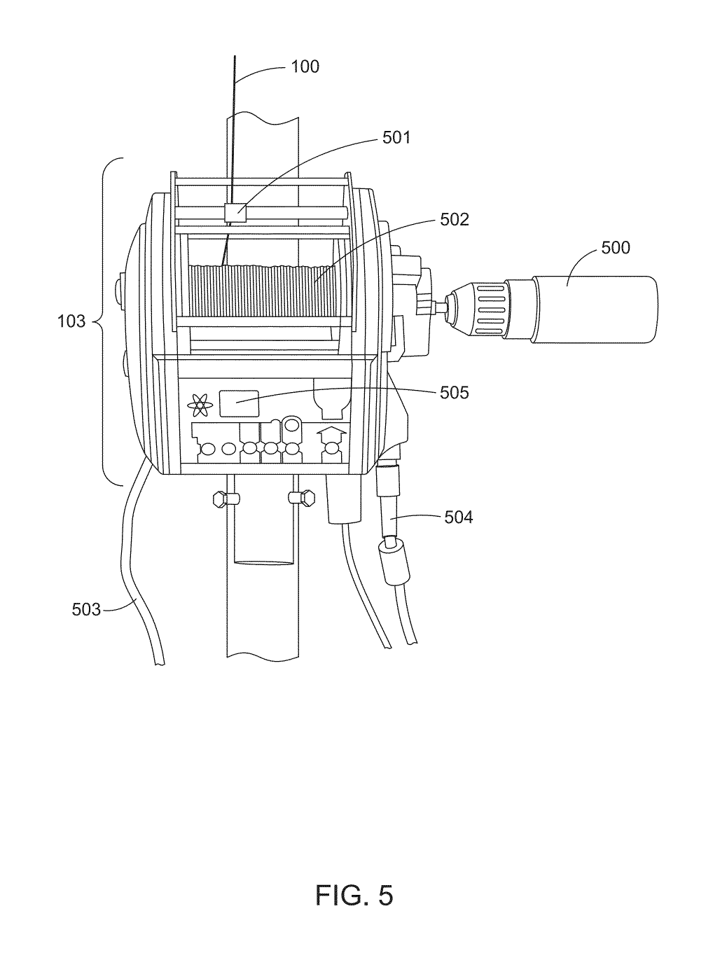

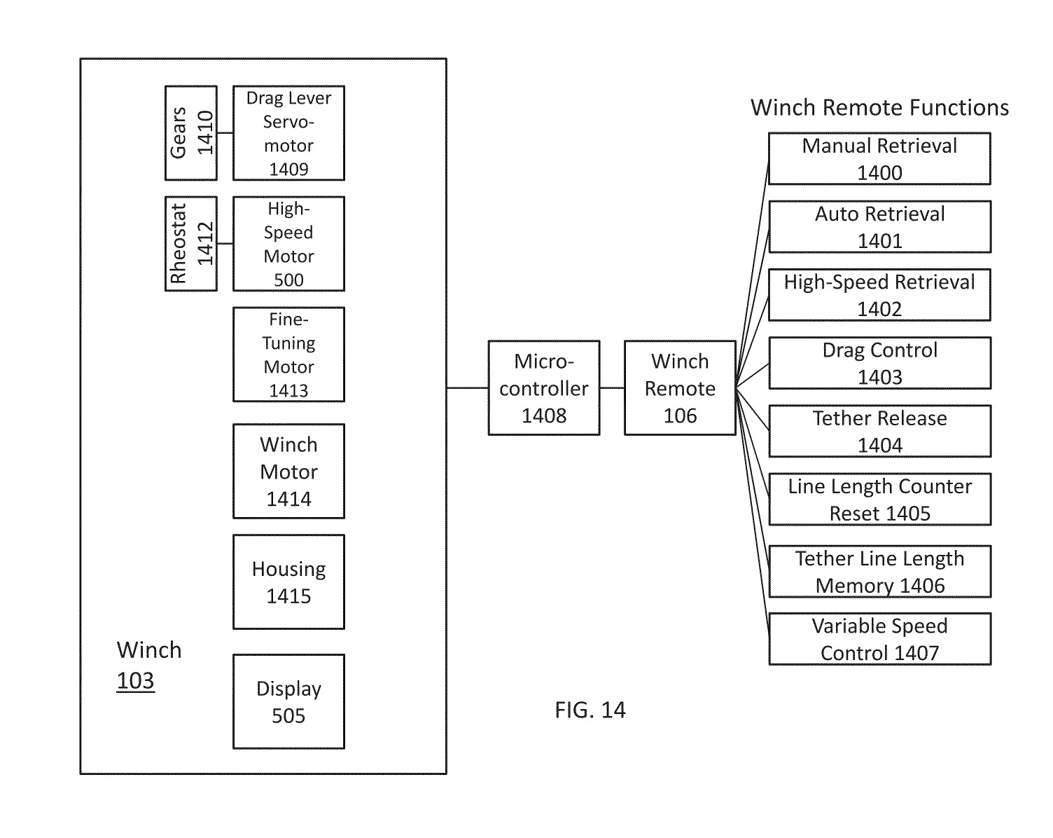

As shown in FIG. 14, the winch remote 106, coupled with the SUA remote, can provide all the functionality an operator needs to fly a SUA 150 attached to the tethered flight control system 101: the operator has the ability control the SUA using the SUA remote and the operator can control the SUA from the ground using the winch 103 should winch control become necessary or desirable. The foot pedals 109 enable the operator to control the various winch 103 functions. Separate pedals 109 can be provided to activate the various functions of the winch 103. Alternatively, one or more winch 103 functions could be controlled from a single pedal 109. For example, a pedal 109 can operate (on/off) the high-speed motor (as shown in FIG. 5) that engages directly inside the winch 103's gearbox for slack removal or high-speed retrieval 1402. Another pedal 109 could be added to provide drag control 1403 to allow the operator to activate the mechanical drag lever 201 (as shown in FIG. 2) used to control resistance in the reel of the winch by activating a servomotor 1409 which is attached to the drag level through one or more gears 1410. This can give the operator the ability to increase the tether line drag from no resistance up to a full stop, which can enable the operator to slow the SUA's flight speed up to and including a full halting of the flight. This functionality is also available by manual manipulation of the drag lever 201.

Additional winch functions controlled by the winch remote 106 include, but are not limited to: a tether release function 1404, which can allow a tethered SUA to fly a mission without resistance from the tether line. A manual retrieval mode 1400 can allow the operator to retrieve the tether line through the winch and pull the SUA to a new position or altitude. An auto tether retrieval mode 1401 can allow an operator to maintain a constant tether line retrieval speed without having to maintain pressure on the manual retrieval pedal. A line length counter reset function 1405 can allow an operator to establish a new baseline of tether length prior to a new flight or to track the distance traveled during a flight. A tether line length memory function 1406 allows the operator to designate one or more points on the tether line and can rewind or release the winch to get back to the remembered point in the tether line. Variable speed control 1407 can allow an operator to gradually increase or decrease the SUA retrieval speed by varying the speed the tether line is re-spooled.

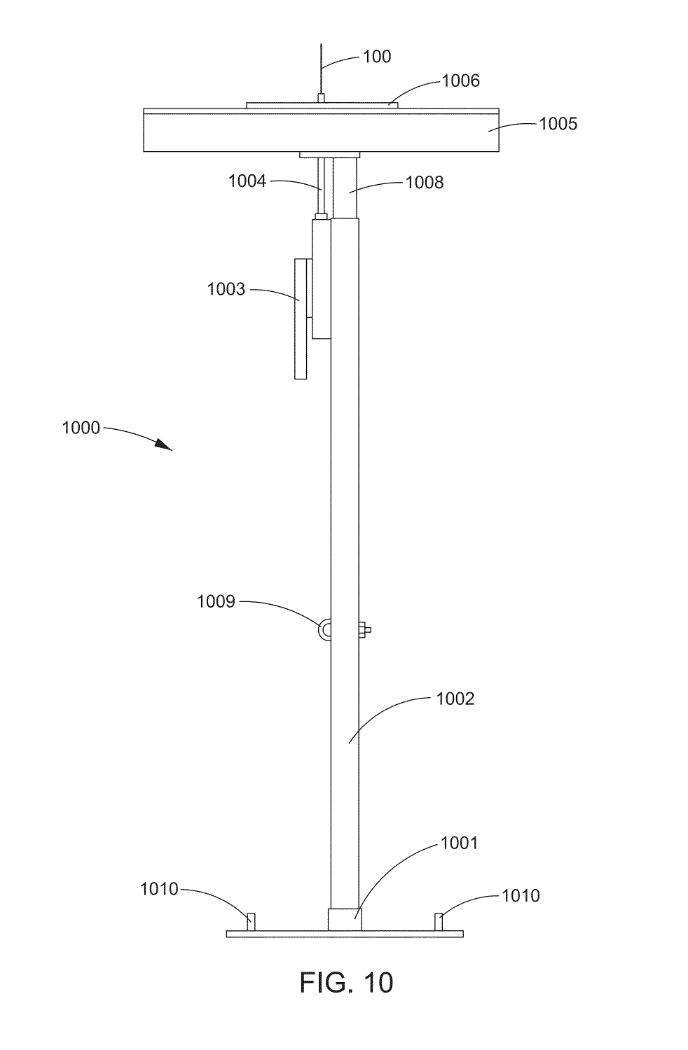

The tether arm can be mounted to a mobile base 105 through the use of a fixation mechanism 107. In some embodiments, the fixation mechanism can be a steel base modified to be inserted into traditional auto tow kit or trailer hitch, with a stabilization cross bar 108 that can stabilize the fixation mechanism 107 to prevent unwanted movement. In some embodiments, tethered flight control system 101 can be permanently affixed to the mobile base 105, in others it is removable. When locked in place, the tethered flight control system can be safe for transportation, eliminating the need to set up and break down at every location. Similar arrangements can be made for stationary bases, such as the exemplary stationary base depicted in FIG. 10-12, a building, sign, or other simple weighted platform, barrel or other relatively heavy device. The tethered flight control system can withstand hundreds of pounds of twist and torque, which can be greater than any demand presented by an airborne tethered SUA, even flying under worst-case weather conditions.

While the mobile base 105 depicted in FIG. 1 is similar to a golf cart, the mobile base 105 can be a vehicle such as a car, truck, or an unmanned ground vehicle. Alternatively, the mobile base 105 could be an aquatic vehicle, such as a boat or cruise ship. Alternatively, the tethered flight control system can be mounted to a dock or pier, including a floating dock.

A water craft, such as a speedboat, outfitted with the apparatus and system described herein could be launched and dispatch via the nation's rivers and harbors to desired locations with the tethered SUA being able to reach areas and perspectives not normally encountered. These deployments add the added benefit to being over water, which the FAA considers to be sparsely populated areas that pose less risk for SUA flights. Many major cities, and even many sporting venues are near one form of water or another, using watercraft as a command and/or deployment center for a tethered SUA provides improved access to much of the country's (and the world's) news centers. Additionally, the mobile base 105 could be selected from any transit system, including cars, busses, trolleys, rail cars, and the like. The mobile base 105 can have a landing cover 110, which can be opaque or transparent, and can be used by the SUA 150 as a landing platform when not in flight.

FIG. 2 is a side view of the exemplary tethered flight control system as shown in FIG. 1. To the base (not shown) a tether arm 104 can be attached. The tether arm 104 is adapted and configured such that at least the upper portion 206 thereof is capable of 360-degree rotation with respect to its vertical axis. That is, at least the upper portion 206 of the tether arm 104 is free to rotate as the SUA moves about the axis. The tether arm 104 extends radially from the fixation mechanism 107 (as shown in FIG. 1) and terminates at its distal end in a tether spout 102 (as shown in FIG. 1). A tether arm extender 208 can fit within the tether arm 104 and can be used to raise or lower the height of the tether spout 102. The position of the tether arm extender 208 can be locked using the extender lock 209, which can be a bolt or other locking mechanism. The tether arm 104 extends radially outward (and may be angled upward) to create a moment arm, such that when the aircraft shifts position laterally, the upper portion 206 of the tether arm 104 rotates, causing rotation of the winch 103, tether arm 104 and tether spout along with it.

Although any method of permitting this rotation may be employed, the figures show an exemplary arrangement where an upper portion 206 of the tether arm 104 is allowed to rotate on a lower portion 205 via a swivel coupler 204. The swivel coupler 204 is installed on lower portion 205 of the tether arm 104 to allow 360-degree rotation to ensure alignment of the winch 103, tether line 100 and SUA 150 in flight at any angle and trajectory.

The tether arm 104 also serves as a mounting surface for a winch 103 including a reel of tether line 100. In some embodiments, the winch 103 is mounted on the upper portion 206 of the tether arm 104, such that when the tether arm 104 rotates, the winch 103 rotates with it; this maintains alignment of the winch 103, tether arm 104, and tether line 100. In an alternate embodiment, the winch 103 may be coupled to the base on a separate pole than the tether arm 104 such that stress (e.g., stress from torque and twist to retrieve the SUA) on the system is isolated on the winch 103 and the base. In some embodiments, the tether arm 104 may extend from the base to a height (relative to the ground or a portion of the base or platform) sufficient to avoid low-lying obstructions on the ground and nearby.

In some embodiments, the tether arm 104 is provided with mounting brackets, braces, shelves, or other apparatus to facilitate the addition or removal of parts, including but not limited to the winch 103, one or more batteries, or a counter balance. In some embodiments these are placed on the upper portion 206 of the tether arm 104 for rotation therewith. An upper outer ring 207 affixed to the tether arm 104 provides an aperture (not shown) into which a mounting plate 203 affixed to the winch 103 is received. A lower outer ring 210, adjustably mounted on the tether arm 104, can be provided to accept the lower tab provided on the mounting plate. The lower outer ring 210 can be raised such that it covers the lower tab of the mounting plate, and then can be tightened into position via a tightening mechanism 202, thereby securing the winch 103. Other types of mounting mechanisms may be employed to attach the winch 103, or the winch 103 or other items (e.g. battery shelves) can be permanently affixed to the tether arm 104.

The winch 103 can have a drag lever 201, which the operator can manually operate in order to increase or lessen the drag on the tether line being acted upon by the winch 103. In an alternate embodiment, the drag lever 201 can be mechanized through the application of servomotors such that operation of the drag lever 201 can be controlled by the operator through the use of the winch remote.

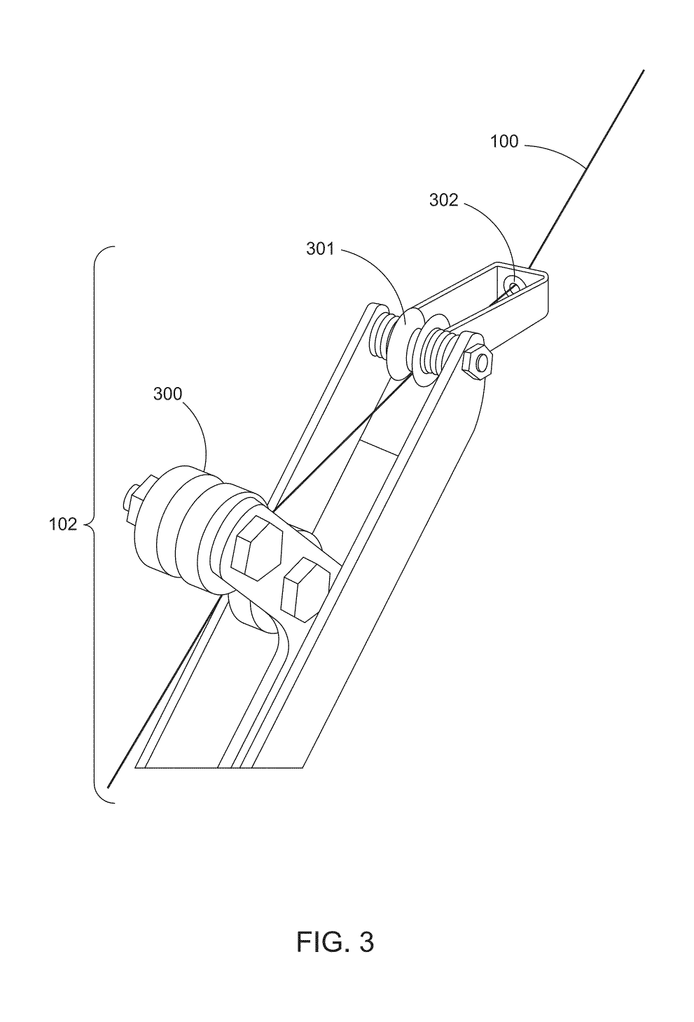

FIG. 3 is a perspective view of the upper portion of the tether spout 102 for use in the tethered flight control system as shown in FIG. 1. The tether spout 102 may be configured to facilitate a smooth releasing and retrieval of the tether line 100 while in operation. The tether spout 102 can guide the tether and provide smooth retrieval of the SUA at a plurality of different angles relative to the base, such as at angles of 90 degrees and higher. Accordingly, the tether spout 102 may be configured to provide retrieval of the SUA at any angle from 0 to 360 degrees without the SUA being tangled or caught up in the tether line 100. The tether spout 102 can have a pivot 301 which can rotate in a vertical direction to track the vertical movement of the SUA. As shown, the tether line 100 can be protected by one or more pulleys or rollers 300 designed to keep the tether line 100 on its desired path from the winch out through the tether spout orifice 302. The tether spout 102 can ensure alignment of the tether line 100 between the winch and SUA in flight regardless of angle or trajectory of the aircraft and can allow a smooth release and retrieval of the tether line 100.

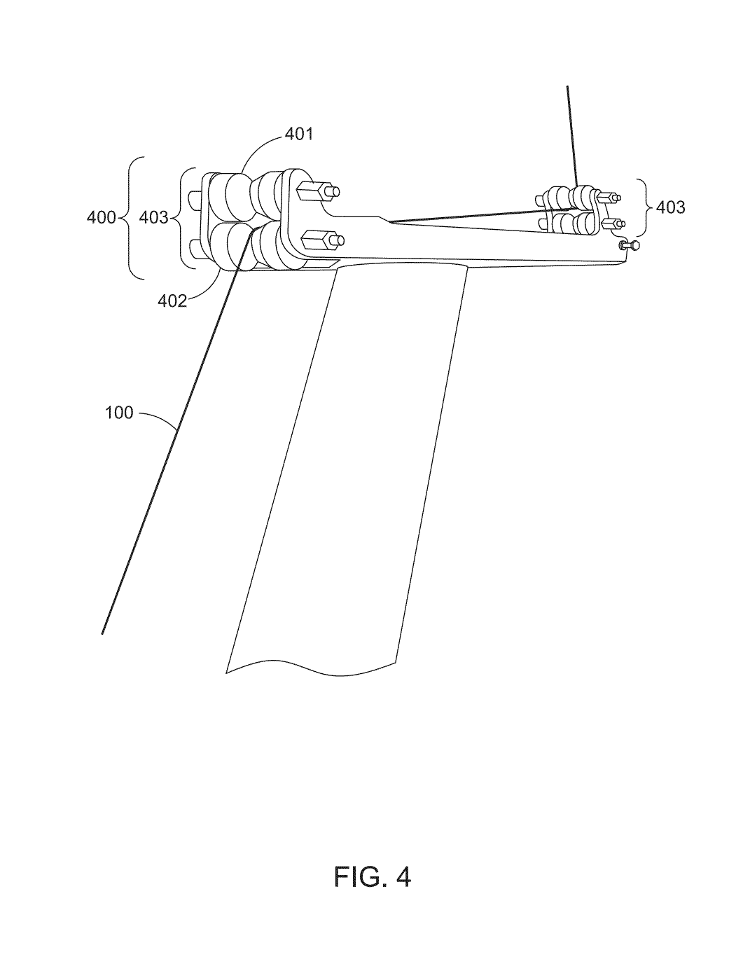

FIG. 4 is a perspective view of an alternate embodiment of the upper portion of the tether spout 102 for use in the tethered flight control system as shown in FIG. 1. In the alternate embodiment, the tether spout 400 can terminate in two sets of rollers 403, each set containing an upper roller 401 and a lower roller 203. The roller sets 403 can ensure alignment of the tether line 100 through all ranges of motion of the SUA.

FIG. 5 is a perspective view of a winch 103 for use in the tethered flight control system as shown in FIG. 1. The winch 103 can be employed to facilitate reeling out and reeling in the tether line 100 on the winch reel 502, and thus controlling the SUA. To ensure effective and repeatable reeling and unreeling of the tether line 100, the winch can have a tether line guide 501 that can laterally move inside the winch such that the tether line 100 neatly reels into the winch 103.

Any suitable winch 103 system can be adapted, or specially built for the purpose. The depicted embodiment features a winch 103 featuring a hard-wired remote control (not shown) connected to the winch through the winch control wire 504. The winch 103 can be provided power through a winch power cord 503. The power can be supplied by an suitable power generation means, or can be supplied from the mobile or stationary base. The winch 103 can have one or more displays 505, which can be used to provide the operator with visual status reports of various winch functions, such as speed, drag level, or a tether extension measurement.

The winch 103 system can be provided with a separate, high-speed motor 500 to permit high-speed retrieval, particularly for taking up tether line slack, such as to avoid entanglement of the SUA caused by slack, or for emergency retrieval. In an embodiment, the high-speed motor 500 can be attached or installed directly into the winch 103's gearbox whereby slack in the line can be removed at a far faster rate than the winch 103 offers. This can enable the operator to more quickly remove the SUA from a dangerous situation (such as people, animals, or other aircraft entering the SUA's zone of operation while in flight) than would otherwise be possible through sole use of the winch motor.

In an embodiment, the high-speed motor 500 can vary the additional retrieval speed from a very high speed down to essentially a zero speed. The variable speed can be achieved by the attachment of a rheostat 1412 to the high-speed motor 500 controlled by a microcontroller 1408, which can control the amount of power provided to the high-speed motor 500. In an embodiment, the high-speed motor 500 can enable retrieval of the SUA at a rate of 400 feet in 12 seconds compared to the winch's maximum speed of 400 feet in 1 minute 53 seconds, which is effectively ten times faster. Even higher speeds can be achieved by installing a motor that provides greater rotations per minute (RPM) capacity.

A benefit of the high-speed motor 500 is that it can substantially eliminate slack in the line as the aircraft moves. In one embodiment, slack can be removed as fast as the SUA can fly, which essentially allows for the complete elimination of slack. This ensures that the tether line 100 will not get caught in lower lying trees, landscaping and other objects that would become problematic as the line slack drops toward the ground during flight. Although the high-speed motor 500 can be manually controlled, it can also be outfitted with sensors to detect the tension in the tether line, or otherwise communicate with the various remotes or aircraft to determine automatically when to take up slack or coupled with a tensioning system to facilitate release of the tether at a rate consistent with the speed of the SUA, eliminating slack before it occurs. Alternatively, the winch 103 can be modified to have reel speeds necessary to compensate for slack production.

Coarse and fine tuning adjustment features can be enabled by a fine-tuning motor 1413, which can enable smaller tension adjustments than the winch 103 or the high-speed motor 500. In an embodiment, the fine-tuning motor 1413 can be a set of stepper motor tensioners controlled by the microcontroller 1408, which can be controlled from the winch remote 106 through one or more pedals 109 or buttons. The fine-tuning motor 1413, winch 103, and microcontroller 1408 can be held within a protective housing 1415 for aesthetic and safety purposes.

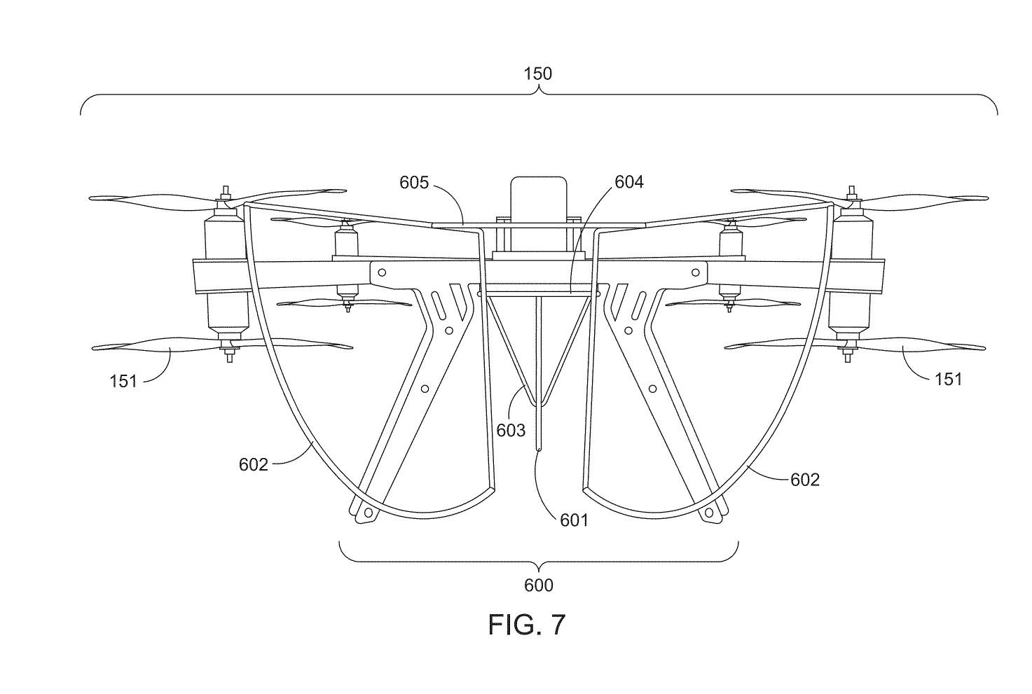

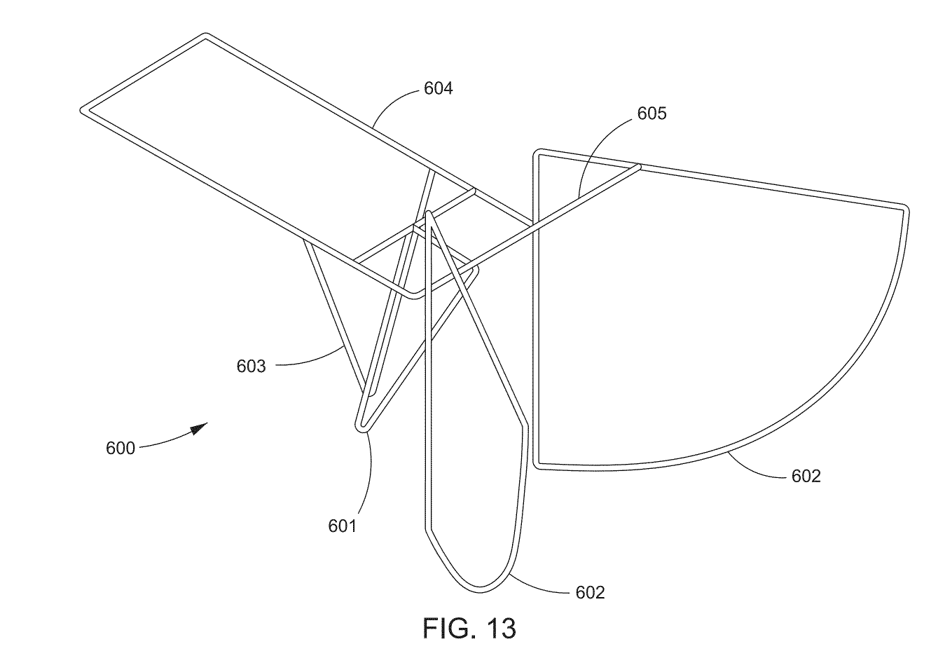

FIGS. 6 and 7 show views of a small unmanned aircraft (SUA) 150 with a tether attachment apparatus 600 for use in the tethered flight control systems as described herein. FIG. 13 depicts the tether attachment apparatus 600 separate from the SUA. The tether attachment apparatus 600 may be coupled to the underbody of the SUA 150. The tether attachment apparatus may be located and configured to safely fly, retrieve and facilitate the avionics of the SUA while allowing the tethered flight control system to retrieve the SUA 150 and tow it back to the base. The tether attachment apparatus can be made from metal, plastic, or composite materials, which are preferably lightweight so as not to impede the maximum flight speed of the SUA 150.

The tether attachment apparatus 600 can include a mounting portion 604 and a tether travel bar 601. The mounting portion 604 may take any shape, size and configuration, depending on the SUA 150 to which it is attached, and can accommodate access to the SUA as needed, such as for battery removal and replacement. The tether travel bar 601 can be the bar to which the tether line 100 is attached. The tether line 100 can be affixed to the tether travel bar 601 via a knot, a clasp or similar attachment mechanism. The tether travel bar 601, as shown in FIGS. 6 and 7 may be a substantially linear bar angled with respect to the SUA. As shown, the tether travel bar 601 extends downward from the SUA and its lowest point 610 (see FIG. 6) is located close to the central axis of the aircraft. This allows the tether line 100, being located near the lowest point 610, to allow the SUA to travel without restriction in a vertical direction. Its upper portion 611 is located near the bottom of the aircraft and will align itself closest to the base, when the tether line is taut, allowing the SUA full range of horizontal movement. This angular design can cause the attachment mechanism to travel up and down the tether travel bar 601 as needed.

As all SUA include rotors 151, these rotors 151 can present an entanglement issue with the tether line, leading to a potential catastrophic failure of the SUA. In an embodiment, two rotor protectors 602 are provided which allow the tether to engage and slide along the rotor protectors 602 to avoid the rotors 151, regardless of the position of the rotors 151 or the tether line. The rotor protectors 602 can be shaped as quarter circles to adequately protect the tether line from contacting the rotors 151, whether the SUA 150 is being moved by the tether line in vertical direction, horizontal direction, or a combination thereof. Alternate embodiments contemplate alternate geometries for the rotor protectors 602, such as rectangles or triangles. The distance between the rotor protectors can be dependent on the positioning of the rotors 151 for a particular model of SUA. For additional structural support, a support bar 605 can be mounted between the rotor protectors to prevent any bending or distortion in high-stress conditions.

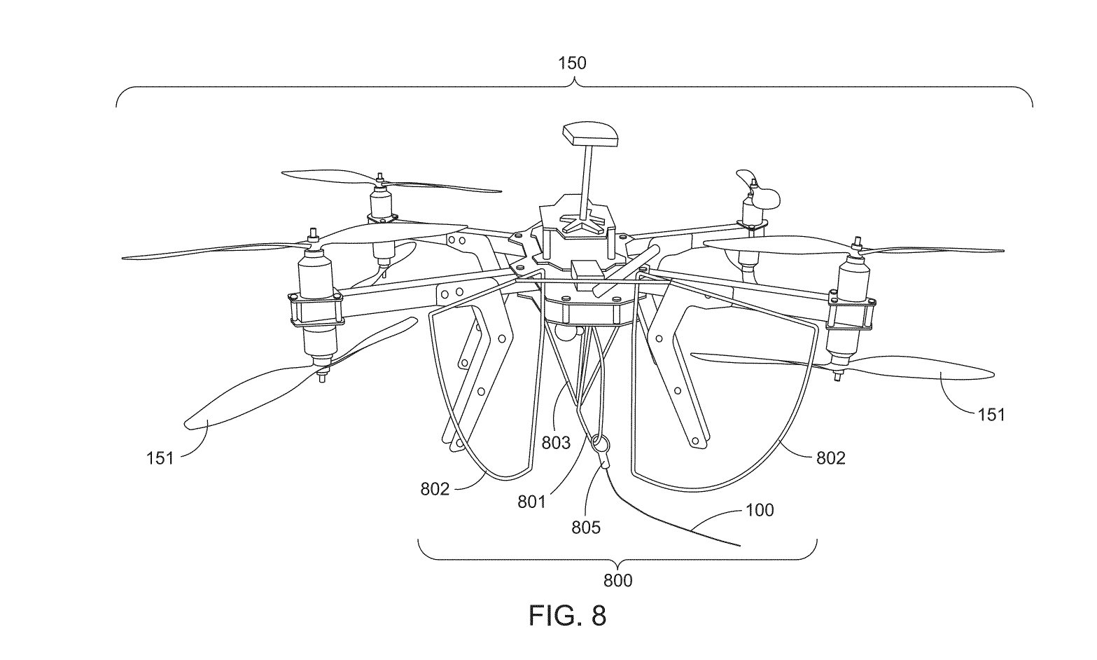

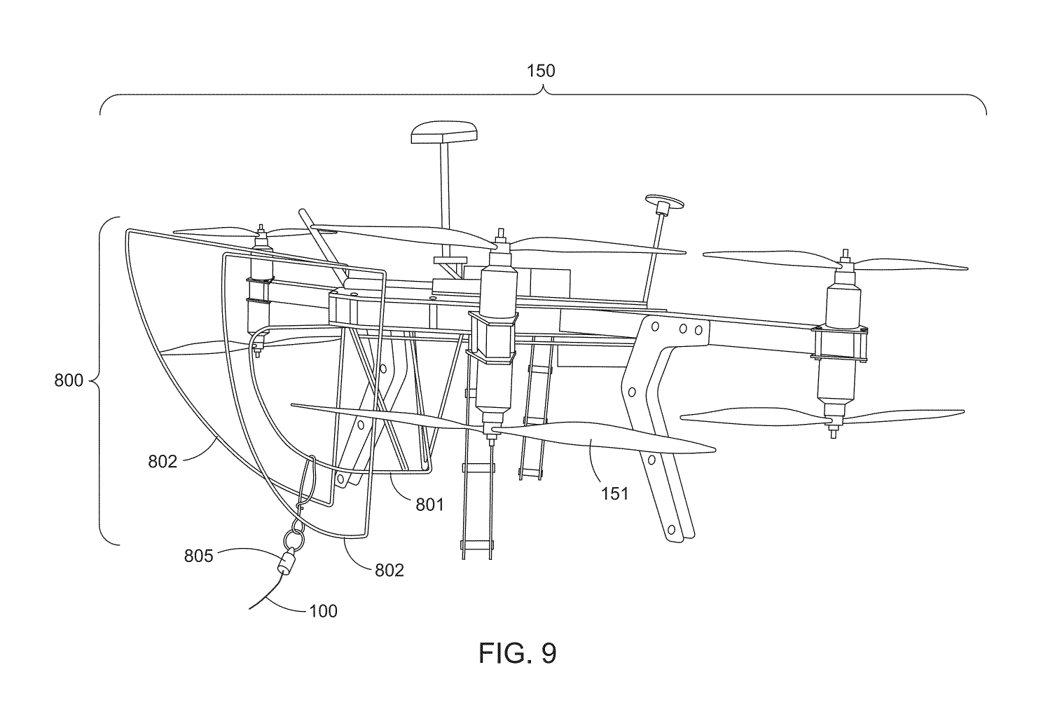

FIGS. 8 and 9 show perspective views of a SUA 150 with an alternate embodiment of a tether attachment apparatus 800 for use in the tethered flight control system. As in the embodiment depicted in FIGS. 6 and 7, the tether attachment apparatus 800 can have a mounting portion, a tether travel bar 801, one or more rotor protectors 802, and a support bar. In contrast to the previous embodiment, the tether travel bar 801 can be curvilinear. To facilitate freedom of movement and limit restriction, a clasp 805 can be coupled to the tether line 100 via a swivel. The clasp 805 is allowed to travel up and down, and rotate on the tether travel bar 801 in response to movement of the tether line 100 relative to the SUA 150 as it moves. The clasp 805 can be used in any embodiment. Through the curvilinear design of the tether travel bar 801, the clasp 805 is less likely to inadvertently slide on the tether travel bar 801 until an adjustment is needed.

FIG. 10 is a side view of an exemplary stationary base 1000 for use with the tethered flight control system as shown in FIG. 1. The stationary base 1000 can include a base plate 1001 and a vertical stand 1002 which can be removably connected to the base plate 1001, configured to provide a center of operations and ground the system to facilitate the release, flight and retrieval of the SUA on demand. The stationary base 1000 may be located on the ground or mounted to another surface through the use of one or more mounting bolts 1010. The stationary base 1000 can be mounted on a mobile platform such as a truck bed, railcar, ship deck, etc. The stationary base 1000 can be made from materials that include metal, wood, composite materials, polymers, or a combination thereof. In some embodiments, the stationary base 1000 may be heavy, with a concentration of the weight located in the base plate 1001 to ensure the stationary base 1000 remains upright during adverse wind conditions. Embodiments may, however, include a stationary base having a lighter weight. The stationary base 1000 can include a takeoff and landing platform 1005 which can establish a reliable, level and safe place for the SUA to take off and land. The takeoff and landing platform 1005 may be coupled to the vertical stand 1002. A tether guide 1004 may be used to guide the tether line 100 through the center of the takeoff and landing platform 1005. The tether guide 1004 can be a hollow pipe of sufficient diameter to admit the tether line 100. In alternate embodiments, the tether guide may act as an extension device that couples to a tether spout (as described above), and may be used to extend the tether spout beyond the level of the takeoff and landing platform 1005. Various types of hardware or mounting points 1009 may be used to couple or stabilize the stationary base to the ground or other stable platforms. The winch (not shown) can be mounted to the stationary base 1000 through the use of a winch mount plate 1003, which can be mounted at any point along the vertical stand 1002. The stationary base 1000 may also include an automated enclosure (not shown) for the SUA in between flights to protect it from the elements.

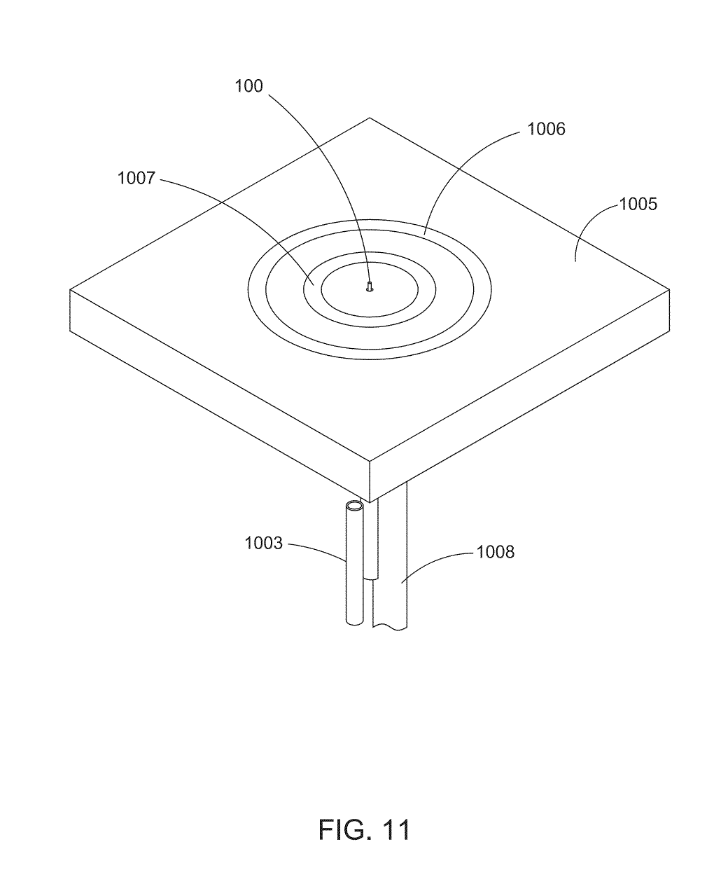

FIG. 11 is a perspective view of the takeoff and landing platform 1005 of the exemplary stationary base. In some embodiments, the takeoff and landing platform 1005 may include a ferromagnetic material (e.g., steel) or other material (e.g., wood, plastic or other materials) having one or more ferromagnetic material portions (e.g., metal rings embedded in the wood) 1006. In this manner, the takeoff and landing platform 1005 may be configured to be attracted to one or more magnets located on the SUA to facilitate the landing of the SUA. The magnetic attraction may assist the tether line 100 in holding the SUA down on the takeoff and landing platform 1005 during adverse conditions. Alternatively, the takeoff and landing platform 1005 may use conventional methods, such as a sliding track (not shown) and a carabiner (not shown) to hold down the SUA on the platform. Because the takeoff and landing platform 1005 can be mounted above the winch and the tether line 100 is configured to go through the center of the takeoff and landing platform 1005, the SUA may, as it nears the platform, move in a more uniformly vertical direction toward the platform, providing a more reliable landing.

Additionally, the takeoff and landing platform 1005 can act as a SUA recharge station by containing one or more areas of electrically conductive material 1007, which can, when contacted by corresponding areas of electrically conductive material on the SUA, transfer power from through the stationary base into the SUA.

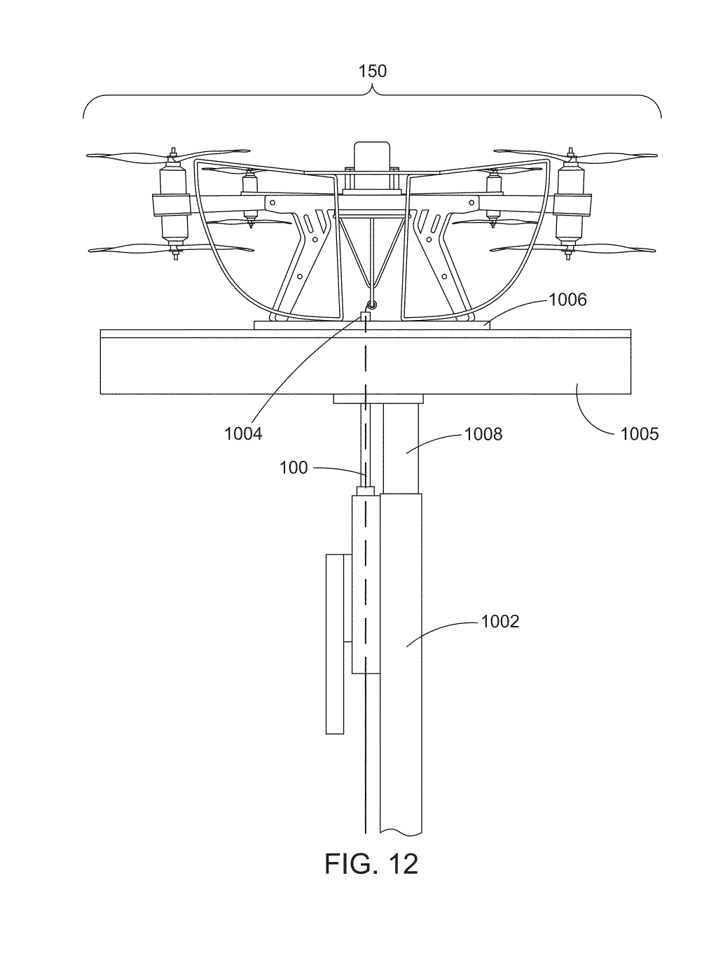

FIG. 12 is a side view of a small unmanned aircraft 150 parked on the exemplary stationary base. As described above, the SUA 150 can be firmly affixed to the takeoff and landing platform 1005 through an application of electrical current to the ferromagnetic material 1006, which can induce a magnetic field that prevents the movement of the SUA. Additionally, the stationary base 1000 can include an extension pole 1008 contained inside the vertical stand 1002, which can be used to raise or lower the height of the takeoff and landing platform 1005.

Embodiments disclosed herein can provide an aerial media system and method for autonomously acquiring news data (e.g., visual images and audio data) from higher locations within a range of altitude above ground. In some embodiments, the allowable range of altitude for acquiring the data may be regulated by the Federal Aviation Administration (FAA). Embodiments can utilize data acquisition systems (e.g., microphones, imaging devices) coupled to SUA to acquire live news data for immediate online public consumption in detail greater than conventional data acquisition systems allow. The aerial media system can integrate the autonomous SUA with autonomous unmanned ground vehicles through the tethered flight control system, enabling remote control (via GPS, radio-frequency driven remote control, or on-board sensing technologies) of SUA location, camera angle and microphone placement to acquire and relay live news occurring in public spaces.

Embodiments can provide unique fields of view that can enable efficient augmented reality overlays on mobile devices or other consumer electronics. Consumers may select on superimposed options, such as access to experts, for instance, joint investigative team journalists who are on selectable issues. Consumers may also select options that offer radio and TV traffic reports as well as published reports via the internet or social media platforms.

In some embodiments, the aerial media system can provide social media connectivity to mass audiences. Consumers can contribute content, including text, video, audio, or photos to system media platforms. Consumers can connect to the network to contribute suggestions for news coverage, and communicate with each other regarding news coverage in ways that are impossible or impracticable using social media with traditional media and news gathering methods alone. Consumers may access social media via selecting restaurant reviews, personal profiles, company profiles, and other information available by social media, prompted to consumers. Embodiments can include autonomous acquisition of ambient audio data below the range of altitude relative to acquisition of images above. The aerial media system may include scalable system components to efficiently increase an audience base. These scalable system components may be advantageous over conventional non-autonomous news-gathering systems unable to achieve scalability.

The aerial media system can provide consumer confidence: by having an aerial view of their neighborhoods and local life and enabling people to plan, learn and act with more informed awareness, ease and efficiency. Embodiments can provide marketable consumer insights. The aerial media system may reach a mass audience via mobile and other digital devices. Thus, the aerial media system may capture consumer interests in a real-time basis, providing advertisers with consumer insights unavailable today.

Embodiments can provide micro-local news and insight. Consumer appetite for local news is strong and increasing. Social media is the leading source for local news among consumers who use social media. The aerial media system can enhance the social media experience by creating a micro-local medium where neighbors can gather news about their local lives first-hand and share that information across the aerial media system's platforms, and also through and with their social media communities.

Embodiments can provide commercial opportunity to owners/operators of fixed assets near points of public interest. For example, a commercial agreement may be made between the aerial media system and a billboard company that owns properties near major points of interest in many neighborhoods across the country. A company, such as a billboard company or sports arena owner, could offer its customers new premium services. By taking their clients sky-ward, they can offer their advertising clients exposure not just at that particular billboard location, but also to the aerial media system's mass audience.

Tethered SUA systems can be used for business information gathering, such as monitoring traffic patterns and volumes, and infrastructure monitoring such as structural monitoring of bridges, buildings, water towers, and parking lots. In expeditions over unknown or rough terrain, a tethered SUA system as described herein could be deployed with a camera from an all-terrain vehicle (or other vehicle) so that the operator could avoid obstacles ahead before reaching them. In a commercial boating application, a tethered SUA could be mounted to a ship and used with a camera or other sensor to scout for boat traffic, fish, or to extend the visual range for pirate activity. Although the present system allows for some degree of flight below the horizontal, the tether attachment apparatus could be modified specifically for such flight patterns as needed for assessing structural elements, cliff faces, or below-ground caves. In the media outlet industry, strategic sites throughout a city or other location such as brownfield sites, abandoned parking lots, and warehouse spaces all offer media outlets a vantage point normally unavailable to them. These locales would offer a lower cost per photo trip/shoot, since the media outlet could deploy a single operator/operator to control the tethered SUA, and a reporter either remotely or on the ground.

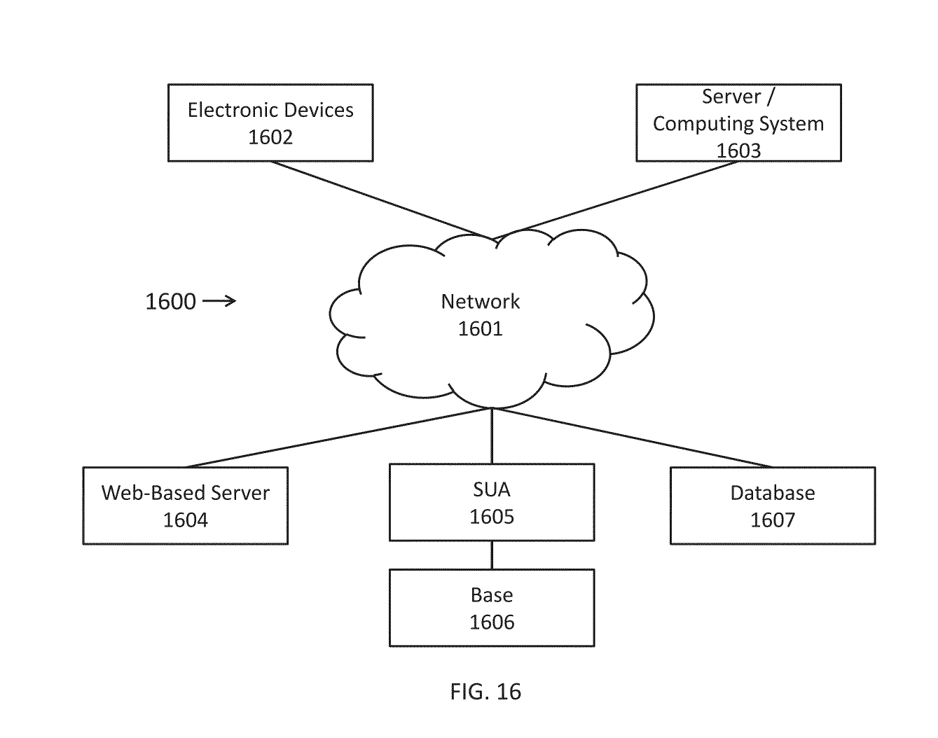

FIG. 16 is a system diagram illustration of an aerial media system 1600 for use with embodiments described herein. As described in FIG. 15, the SUA 1605 may include a camera, microphone, and a transceiver to receive and transmit data as well as a ground computer which can be used to send instructions to the SUA components coupled to the SUA and receive data from the same. The aerial media system 1600 may also include a base 1606 coupled to the SUA by a tethered flight control system as described herein. The aerial media system 1600 may further include consumer electronic devices 1602, a web based server 1604, a database 1607, a server/computing system 1603 and a network 1601.

The SUA 1605 and aerial media system 1600 may be controlled to autonomously acquire news data from locations within a range of altitude regulated by the FAA. For example, one or more SUA data acquisition systems may be controlled to autonomously acquire news data from locations within a range of altitude.

Embodiments can include an aerial media system 1600 that includes a tethered SUA that can operate legally in the heavily regulated United States airspace. An aerial media system kit may include components to capture and stream HD video from any location, and may include one or more SUA and tethered flight control systems. The aerial media system kit may be a base or a mobile suitcase that includes the SUA and aerial media system, a control computer, multiple battery packs, multiple Wi-Fi access points/range boosters, a SUA controller, a cellular data module (or other data module based on location), and a tether line. The aerial media system can be installed to a specified site such as a rooftop, billboard, or tower. Alternatively, one or more operators can deploy one or more portable aerial media system kits which can be packed up and reused anywhere.

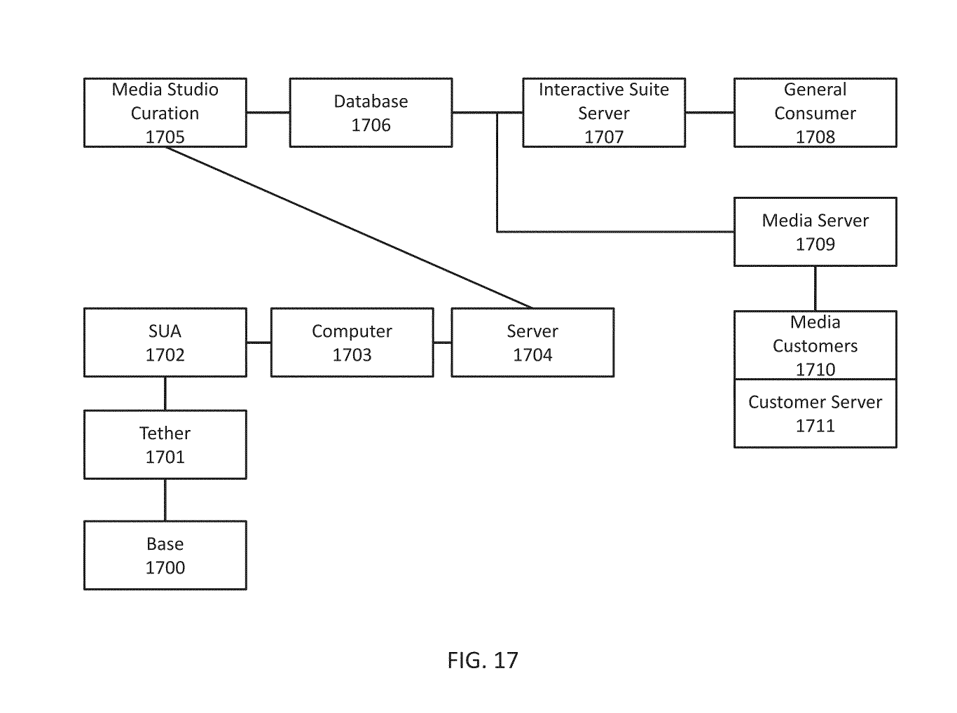

FIG. 17 is a system flow diagram illustrating an exemplary method of acquiring and providing news data in an exemplary aerial media system according to embodiments described herein. Images captured by a camera aboard the SUA 1702 attached to the base 1700 through the tether 1701 can be conveyed via wire or wirelessly to a computer 1703 located at ground level, which can then convey the digitized images to the aerial media system server 1704 and onward to a media studio 1705 for curation. Once curated, the images, related text and voiceovers can be conveyed to a database storage controller 1706 to enable customer access. For media customers 1710, the image products are loaded onto a media server 1709 to enable media customers 1710 access to the images and related text and voiceovers, and to provide them to their respective customers through their customer server 1711. For the general public/consumer 1708, the curated images, text, and/or voiceovers can be loaded onto a server 1707 that contains a suite of exemplary interactive computer programs that enable general consumers 1708 to access the content and also interact online with editors, viewers and other participants of the aerial media system that are available via website and accessible by computer or mobile device. The aerial media system interactive suite server 1701 may include different media platforms, such as an expert nomination platform, a news re-reporting platform, and an on-demand platform.

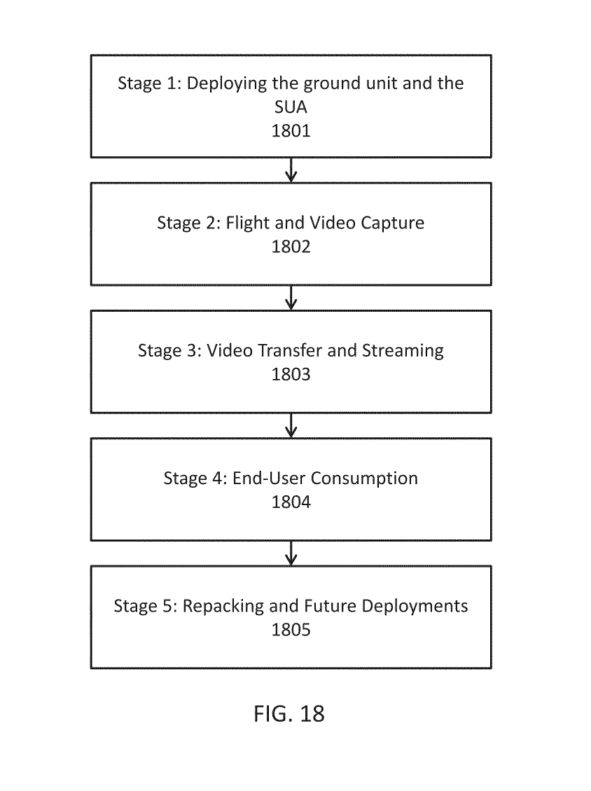

An exemplary method of using the aerial media system may include five stages, as shown in FIG. 18. Stage 1 1801 can involve deploying the base and SUA. In this stage, the operator can unpack or open the suitcase containing the aerial media system. Access points for wireless communication can be pre-mounted either inside the case or to the pop-up structure. The operator can connect the SUA tethering system, where the tether line can secure to the underside of the SUA and to the base. A computer can be booted and video capture/transfer/streaming software can be enabled. In some embodiments, autonomous software can be enabled to upload the SUA flight routes. The operator can perform a pre-flight check of equipment to ensure nothing is loose and all radios (wireless, radio, cellular, or other) are transmitting properly, and to ensure the SUA and tether controls are performing properly. In an embodiment, the SUA camera can be preconfigured and directly attached to the SUA. The camera can be mounted on a gimbal to provide a smooth video feed during all types of flight/weather. As the operator begins flight the method can then transition to Stage 2 1802.

Stage 2 1802 can involve SUA flight and video capture. The SUA can receive flight path instructions from a manual controller operated by the operator or from an autonomous controller. Video capture can be constantly active throughout the flight. The camera can capture live video at any desired resolution and encoding format, and can stream the video via an integrated transceiver to the base computer. The video stream can be transferred from the base computer to a designated datacenter, where the data may be stored and streamed to consumer electronic devices via a network. Third party software may be used to achieve the transfer and minimize delay in any live stream. Depending on the remaining battery life of the SUA, the operator or autonomous controller can elect to either continue flying after the desired footage is captured or to return to the ground control unit for a recharge. Footage can be constantly captured but does not necessarily need to be constantly streamed. In some embodiments, the video stream may be disabled during transit to and from a location. The method can then transition to Stage 3 1803.

Stage 3 1803 can involve video transfer and streaming. When the initial video feed has begun streaming/transferring to the datacenter, the process of storing and redistributing/streaming the video can begin. Video files can enter the datacenter and can be routed to a leased/collocated server cabinet. The server may use a high storage capacity database, and may moderate processing power either through rented cloud computers or custom-built systems for streaming. Once the video is stored, streaming software can encode the video in a lower resolution format than the format of the received video. All resolutions, including 4K, 1080p, 720p, 480p, 240p, can then be streamed via third party software and/or a custom-built website, which can be hosted in the same server cabinet. All formats can be stored in a database for later distribution or resale. Stills and video clips can be indexed and pulled from the database to be sold to media outlets and media resellers. In some embodiments, a user-controlled DVR function may be used by the consumer. An additional database for user accounts and the storage of recordings may also be used. DVR functionality can be disabled by default to protect monetization but can be enabled at a later date. The method can then transition to Stage 4 1804.

Stage 4 1804 can involve end-user consumption. The video stream can be webcasted to end user devices via a custom website and/or third party applications for mobile devices. End users can navigate to the website through a browser or an app and choose from several video streams, which can all propagate from different deployment locations. Advertising overlays can be enabled on the website and/or mobile applications to monetize the video content. Localized advertisers catering to live stream viewers may be targeted, but the system can be open to any advertising options, such as commercials that vary while the SUA travels from location to location or commercials if and when a SUA image feed is unavailable due to weather. In some embodiments, users may interact with the live stream to provide feedback as well as interact with each other. User-suggested routes and user-submitted content may also be used by the system. Users may deploy their own SUA and generate revenue from a media channel. It should be recognized that Stages 1 through 4 can be employed separately or with substantial overlap depending on the need. The method can then transition to Stage 5 1805.

Stage 5 1805 can involve repacking and/or future deployments. When the video stream has finished traveling from the camera on the SUA to the final consumer, the overall task can be considered complete and the operator may return the SUA to the base, shut down the computer, and pack away the SUA, computer, access points, and any extra batteries. The aerial media system can be deployed to another location by the operator.

In another embodiment, the SUA can be secured to a fixed location such as a stationary base, billboard, tall building, or tower structure. In yet another embodiment, a customer may deploy and operate the SUA, controlling the flight process and location. Due to the preconfigured nature of the aerial media system's platform, a customer-deployed SUA may still feed video to the same server cabinet in the datacenter. This data can be locked to a specific user account so that it remains private from the general user base of the aerial media system. Users can monetize their own content and a person or entity having rights in the aerial media system may receive a royalty percentage. In another embodiment, a person or entity having rights in the aerial media system may monetize content for end-users, selling it to media outlets and giving end-users a percentage instead.

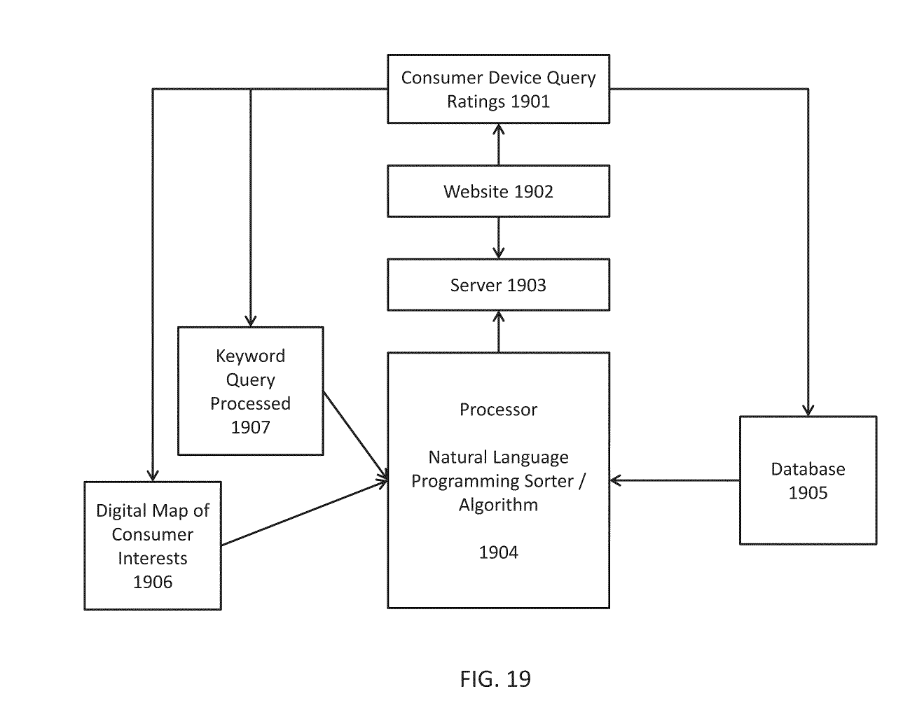

FIG. 19 is a flow diagram illustrating an exemplary method of implementing the expert nomination platform. The expert nomination platform can be one embodiment of the aerial media system interactive products that can enable consumers to view public activity from a sky-based vantage point, as well as to gain access to others who are experts on topics or questions stimulated by the sky-based view on their screen. Consumers may select a point of interest 1906 visible on the aerial media system website 1902 or enter a keyword or hashtag 1907 naming the topic of their interest. Queries can be transmitted to a processor 1904 where a set of criteria can be applied via an algorithm whereby posts from the most qualified experts on social media platforms are selected in response to the consumer's query. The list of qualified responses can be sent to a server 1903 and then posted for consumer access on the aerial media system website 1902. The sorting process selecting the most qualified responses can be enhanced by user ratings of the social media posts (for example, Facebook™ “likes” or up votes), whereby consumers can rate the quality of the information shared on the social media platform, which can then be recorded in a database 1905 and incorporated into the processor 1904 as part of a continuous loop.

In one embodiment, the expert content suppliers may be filtered with a methodology based upon Natural Language Programming (NLP). Filters based upon linguistic studies of statements by trusted experts can be used to create filters that can find the most reliable experts on any given topic. These filters can serve as weighting metrics, which can bring the best experts to the top of the expert list (very high weight). The following criteria can also be used, on a weighted basis, to distill and suggest the best experts forward for users of the aerial media system: Number of social media followers (high weight); Number of social media posts (medium weight); Follower numbers (low weight); Quality of attachments offered to readers (the aerial media system may predetermine which sources have the greatest credibility) (medium weight); Location of social media posts in relation to topic location (medium weight); Photo or no Photo (low weight); Number of re-posts by social media followers (medium or high weight); Time of post versus actual news event or act (medium weight); User rating (high weight). This weighting methodology can then feed prioritized content to the user through the media products described herein that can enable the system to curate the experience for the user. Embodiments may also include expert content suppliers that are filtered with other methodologies.

The expert nomination platform can be a two-sided social media platform to enable dynamic interaction between people, such as leaders in key topic areas and their audiences. The expert nomination platform can screen, filter and rank new expert journalists' levels of established credibility using proprietary methodology. The expert nomination platform can match any topic of interest with the world's most trustworthy experts. The expert nomination platform offers a dynamic environment where the three sides of the media equation are met. Leaders who publish online will be motivated to attract new followers on the expert nomination platform. For example, readers may gain direct and open access to leaders who achieve high ranking credibility and relevant expertise. Advertisers may be attracted to the high quality of demographic gathered by the expert nomination platform.

The expert nomination platform enables members to find the most reputable journalists reporting on popular topics in their community. An exemplary method of accessing a trusted, expert news source may include selecting a location (either address or GPS coordinates) and choosing the size of radius to include in a community. The expert nomination platform may then display an aerial map of the member's chosen community. The member may then point and touch the location of interest, triggering the profile of a citizen journalist that is most trusted to be knowledgeable and accurate regarding matters related to that locale. A hotlink may lead the member to a report by the expert (either to content located on the aerial media system's databases, or on the expert's social media sites, blog, or website). Hotlinks to social media products can enable members to share their discoveries with their social networks.

The news re-reporting platform can be a journalism product that offers the public media justice, enabling visitors, via social media, to provide their choice of story or topic for news re-reporting to pursue. The news re-reporting platform can allow members to voice their opinion by nominating news stories and social media topics, which can allow members to present under-represented or incorrect media reports communications that must be corrected to the general public. Nominations can be made directly on the news re-reporting website/social media platforms, or nominations can be made via the leading social media products, which can then be tallied on the news re-reporting platform website/social media platforms.

The news re-reporting platform can track the voting of members. Real-time, automatic gathering, counting audience input can be utilized. The news re-reporting platform can determine the recipient of the highest amount of votes and can assign journalists to re-cover a news story that was unnoticed, under-served or “botched.” Journalists for the assignment can be sourced using expert nomination as a sourcing tool, which can select the most trusted experts on the topic. The aerial media system can provide the visual content for the reporting conducted by the journalists on assignment. Once approved by the news re-reporting platform editors, the re-reported story may be published and announced to all members for review and feedback.

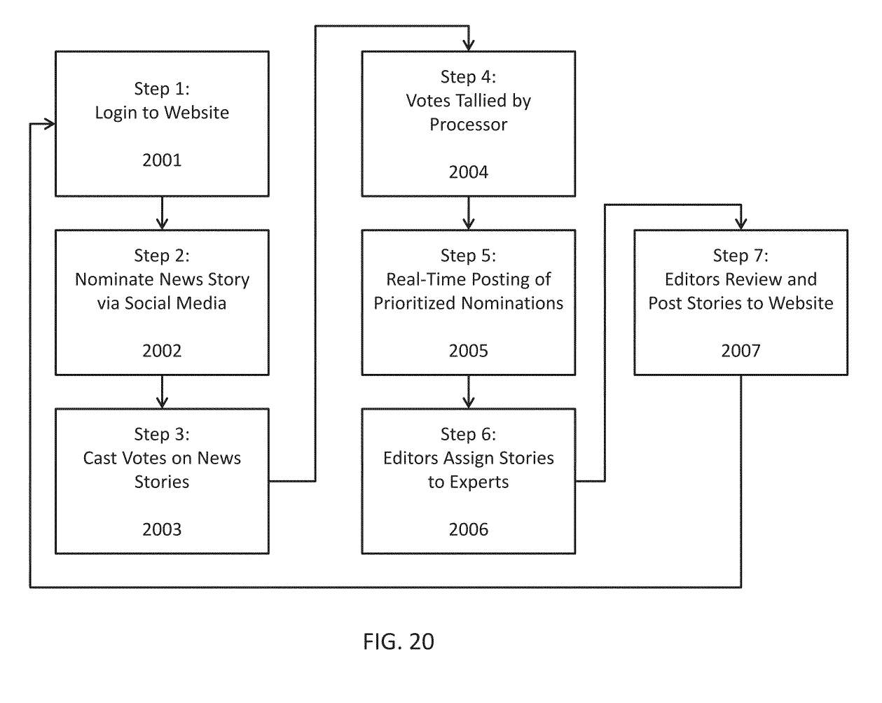

FIG. 20 is a flow diagram illustrating an exemplary method of implementing the news re-reporting platform. In step 1 2001, users of the aerial media system may login to the platform through a website, or by signing in using a social media platform. In step 2 2002, a menu can offer choices for the user to nominate his/her news story found via a social media post. The user can then post the found social media post on the news re-reporting platform website. In step 3 2003, a second menu can appear asking the user to review a current list of social media post nominations and to cast votes indicating the preferred priority of attention to be paid to each post by the news re-reporting platform editorial staff. In step 4 2004, a processor can tally the votes. In step 5 2005, a real-time list of prioritized nominations can be automatically posted/revised on the aerial media system's website. In step 6 2006, the news re-reporting platform editors can assign one or more stories to experts selected from the expert nomination database. In step 7 2007, the news re-reporting platform editors can review and post expert nomination reporters' re-reported story on the top vote-getting stories, and can invite comments and opinions from users. Steps 2 through 7 may repeat numerous times, based upon user demand.

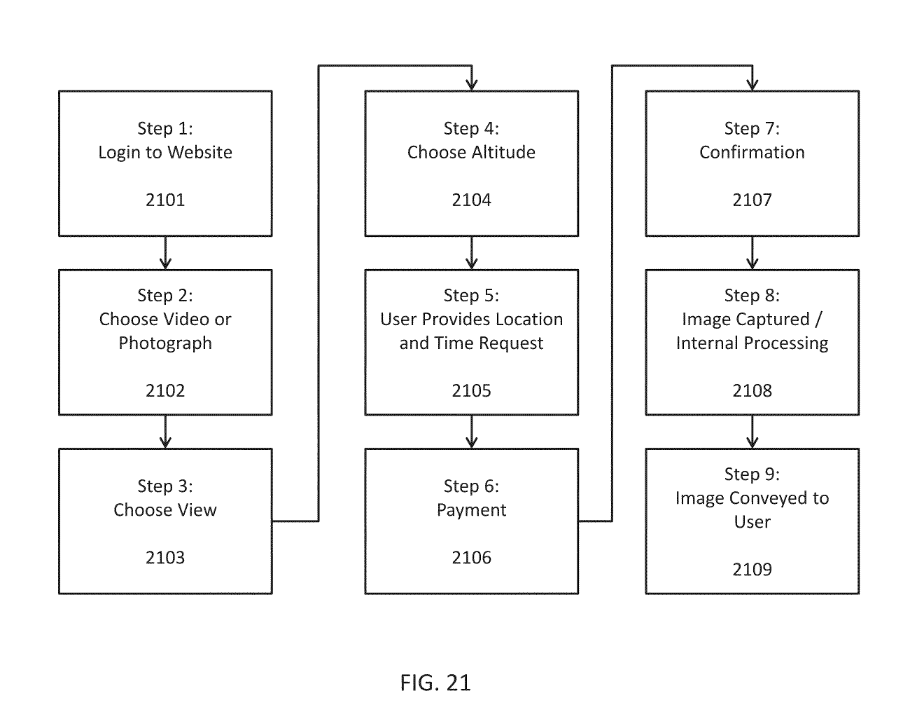

FIG. 21 is a flow diagram illustrating an exemplary method of implementing the on-demand platform. In step 1 2101, users can login to the platform through a website, or sign in using a social media platform. In step 2 2102, a menu can offer the user a selection of a video or a still photograph product. In step 3 2103, a menu can offer image or video view attributes including, but not limited to: panoramic view, 360-degree view, or a zoomed in effect (video only). In step 4 2104, a menu can offer the user a choice of altitude from which the video or still photo will be taken. In step 5 2105, the user can convey via a mobile device his/her chosen location and a preferred time for the photo to be taken by the SUA camera. In step 6 2106, a prompt can appear requesting payment for the transaction. In step 7 2107, a prompt can appear confirming the user's purchase, and the system can send a notification to the user's mobile device. In step 8 2108, the GPS coordinates and photo/video shoot time can be recorded by the system and conveyed by the embodiments described herein to the SUA, which captures the requested image according to the parameters entered by the user. In step 9 2109, the captured image can be conveyed to the user electronically to be accessed at the user's discretion.

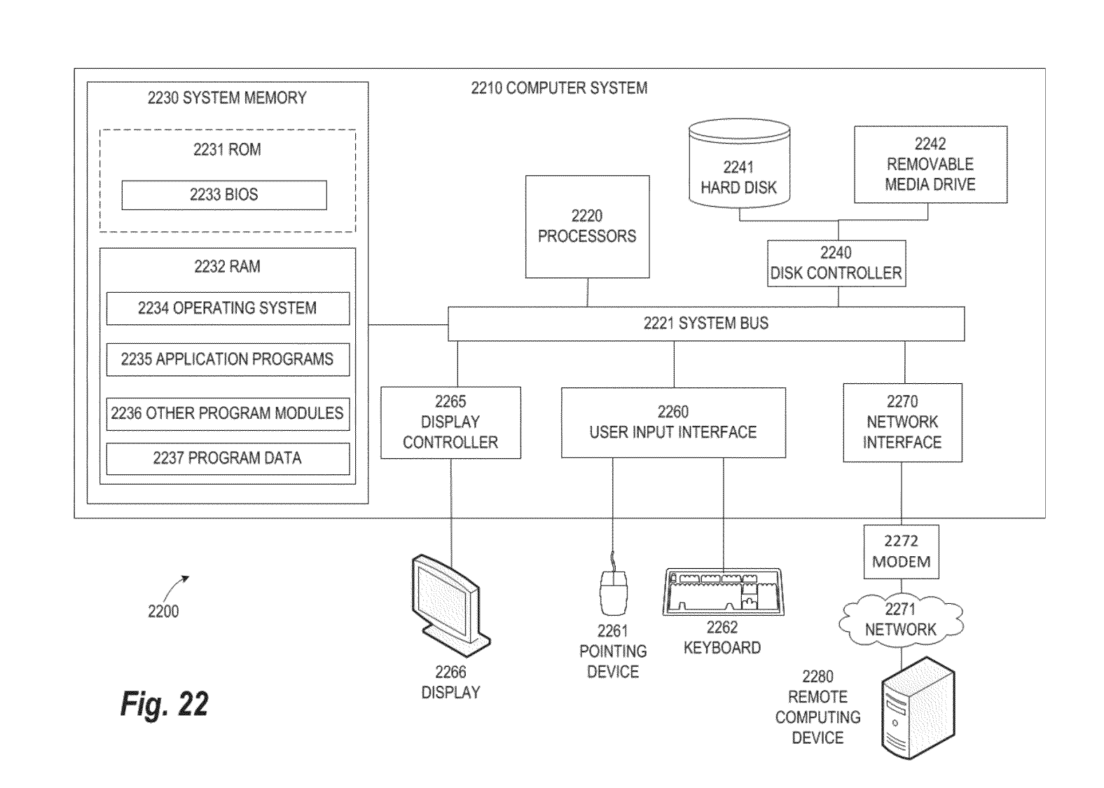

FIG. 22 illustrates an example of a computing environment 2200 within which embodiments of the invention may be implemented. Computing environment 2200 may be implemented as part of any component described herein. Computing environment 2200 may include computer system 2210, which is one example of a computing system upon which embodiments of the invention may be implemented. As shown in FIG. 22, the computer system 2210 may include a communication mechanism such as a bus 2221 or other communication mechanism for communicating information within the computer system 2210. The system 2210 further includes one or more processors 2220 coupled with the bus 2221 for processing the information. The processors 2220 may include one or more CPUs, GPUs, or any other processor known in the art.

The computer system 2210 also includes a system memory 2230 coupled to the bus 2221 for storing information and instructions to be executed by processors 2220. The system memory 2230 may include computer readable storage media in the form of volatile and/or nonvolatile memory, such as read only memory (ROM) 2231 and/or random access memory (RAM) 2232. The system memory RAM 2232 may include other dynamic storage device(s) (e.g., dynamic RAM, static RAM, and synchronous DRAM). The system memory ROM 2231 may include other static storage device(s) (e.g., programmable ROM, erasable PROM, and electrically erasable PROM). In addition, the system memory 2230 may be used for storing temporary variables or other intermediate information during the execution of instructions by the processors 2220. A basic input/output system (BIOS) 2233 containing the basic routines that help to transfer information between elements within computer system 2210, such as during start-up, may be stored in ROM 2231. RAM 2232 may contain data and/or program modules that are immediately accessible to and/or presently being operated on by the processors 2220. System memory 2230 may additionally include, for example, operating system 2234, application programs 2235, other program modules 2236 and program data 2237.

The computer system 2210 also includes a disk controller 2240 coupled to the bus 2221 to control one or more storage devices for storing information and instructions, such as a magnetic hard disk 2241 and a removable media drive 2242 (e.g., floppy disk drive, compact disc drive, tape drive, and/or solid state drive). The storage devices may be added to the computer system 2210 using an appropriate device interface (e.g., a small computer system interface (SCSI), integrated device electronics (IDE), Universal Serial Bus (USB), or FireWire).

The computer system 2210 may also include a display controller 2265 coupled to the bus 2221 to control a display or monitor 2266, such as a cathode ray tube (CRT) or liquid crystal display (LCD), for displaying information to a computer user. The computer system 2210 includes a user input interface 2260 and one or more input devices, such as a keyboard 2262 and a pointing device 2261, for interacting with a computer user and providing information to the processor 2220. The pointing device 2261, for example, may be a mouse, a trackball, or a pointing stick for communicating direction information and command selections to the processor 2220 and for controlling cursor movement on the display 2266. The display 2266 may provide a touch screen interface which allows input to supplement or replace the communication of direction information and command selections by the pointing device 2261.

The computer system 2210 may perform a portion or all of the processing steps of embodiments of the invention in response to the processors 2220 executing one or more sequences of one or more instructions contained in a memory, such as the system memory 2230. Such instructions may be read into the system memory 2230 from another computer readable medium, such as a hard disk 2241 or a removable media drive 2242. The hard disk 2241 may contain one or more data stores and data files used by embodiments of the present invention. Data store contents and data files may be encrypted to improve security. The processors 2220 may also be employed in a multi-processing arrangement to execute the one or more sequences of instructions contained in system memory 2230. In alternative embodiments, hard-wired circuitry may be used in place of or in combination with software instructions. Thus, embodiments are not limited to any specific combination of hardware circuitry and software.

As stated above, the computer system 2210 may include at least one computer readable medium or memory for holding instructions programmed according to embodiments of the invention and for containing data structures, tables, records, or other data described herein. The term “computer readable medium” as used herein refers to any non-transitory, tangible medium that participates in providing instructions to the processor 2220 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 2241 or removable media drive 2242. Non-limiting examples of volatile media include dynamic memory, such as system memory 2230. Non-limiting examples of transmission media include coaxial cables, copper wire, and fiber optics, including the wires that make up the bus 2221. Transmission media may also take the form of acoustic or light waves, such as those generated during radio wave and infrared data communications.

The computing environment 2200 may further include the computer system 2210 operating in a networked environment using logical connections to one or more remote computers, such as remote computer 2280. Remote computer 2280 may be a personal computer (laptop or desktop), a mobile device, a server, a router, a network PC, a peer device or other common network node, and typically includes many or all of the elements described above relative to computer 2210. When used in a networking environment, computer 2210 may include modem 2272 for establishing communications over a network 2271, such as the Internet. Modem 2272 may be connected to system bus 2221 via network interface 2270, or via another appropriate mechanism.

Network 2271 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 2210 and other computers (e.g., remote computing system 2280). The network 2271 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 2271.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. Computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s). A user interface processor or generator is a known element comprising electronic circuitry or software or a combination of both for generating display elements or portions thereof. A user interface (UI) comprises one or more display elements enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A graphical user interface (GUI), as used herein, comprises one or more display elements, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the elements for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display elements in response to signals received from the input devices. In this way, the user interacts with the display elements using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

A workflow processor, as used herein, processes data to determine tasks to add to, or remove from, a task list or modifies tasks incorporated on, or for incorporation on, a task list, as for example specified in a program(s). A task list is a list of tasks for performance by a worker, user of a device, or device or a combination of both. A workflow processor may or may not employ a workflow engine. A workflow engine, as used herein, is a processor executing in response to predetermined process definitions that implement processes responsive to events and event associated data. The workflow engine implements processes in sequence and/or concurrently, responsive to event associated data to determine tasks for performance by a device and or worker and for updating task lists of a device and a worker to include determined tasks. A process definition is definable by a user and comprises a sequence of process steps including one or more, of start, wait, decision and task allocation steps for performance by a device and or worker, for example. An event is an occurrence affecting operation of a process implemented using a process definition. The workflow engine includes a process definition function that allows users to define a process that is to be followed and may include an Event Monitor.

The system and processes of the figures presented herein are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, the processes and applications may, in alternative embodiments, be located on one or more (e.g., distributed) processing devices on a network linking the units of FIG. 22. Any of the functions and steps provided in the Figures may be implemented in hardware, software or a combination of both. No claim element herein is to be construed under the provisions of 35 U.S.C. 112, sixth paragraph, unless the element is expressly recited using the phrase “means for.”

What is claimed is:

1. A tethered flight control system for a small unmanned aircraft, comprising:
a mobile base;
a tether arm extending radially from a fixation mechanism mounted to said base;
a tether spout attached to the tether arm and capable of rotating 360 degrees;
a winch having a reel for holding a tether line having an end and a winch motor configured to reel in the tether line, the winch being configured to be controlled by a winch remote;
wherein the end of tether line attaches to the small unmanned aircraft via a tether attachment apparatus;
wherein the winch, tether arm, and tether spout are aligned such that radial movement of the tether line causes rotation of the tether arm, tether arm, and tether spout to maintain alignment of these components with the tether line and the aircraft.

2. The system as recited in claim 1, the winch further comprising an additional high-speed motor configured to reel in the tether line at a faster rate than the winch.

3. The system as recited in claim 2, wherein the high-speed motor is further configured to retrieve substantially all slack in the tether line while the small unmanned aircraft is in flight.

4. The system as recited in claim 1, the winch further comprising a drag lever configured to control the rate at which the winch allows the tether line to be unreeled.

5. The system as recited in claim 4, wherein the drag lever further comprises servomotors which can be controlled by the winch remote.

6. The system as recited in claim 1, wherein the winch remote is configured to control one or more winch functions using one or more foot-activated pedals.

7. The system as recited in claim 1, wherein the tether arm is mounted to the mobile base using a trailer hitch.

8. The system as recited in claim 1, wherein the mobile base further comprises a landing cover.

9. The system as recited in claim 1, wherein the tether spout further comprises one or more sets of rollers, each set having an upper roller and lower roller, wherein the tether line is configured to thread through the upper roller and lower roller.

10. The system as recited in claim 1, wherein the tether spout further comprises a pivot configured to track the vertical movement of the small unmanned aircraft while in flight.

11. A tethered flight control system for a small unmanned aircraft, comprising:
a stationary base comprising a base plate, a vertical stand, and a takeoff and landing platform;
a winch, having a reel for holding a tether line having an end and a winch motor configured to reel in the tether line, the winch being configured to be controlled by a winch remote;
wherein the end of tether line attaches to the small unmanned aircraft; and
wherein the small unmanned aircraft is configured to rest on the takeoff and landing platform when not in flight.

12. The system as recited in claim 12, wherein the stationary base further comprises an extension pole configured to raise and lower the takeoff and landing platform.

13. The system as recited in claim 12, further comprising a tether guide configured to be inserted into the center of and through the takeoff and landing platform, wherein the tether line feeds though the tether guide.

14. The system as recited in claim 12, wherein the takeoff and landing platform further comprises one or more areas of ferromagnetic material configured to adhere the small unmanned aircraft to the takeoff and landing platform by magnetic force when not in flight.

15. The system as recited in claim 12, wherein the takeoff and landing platform further comprises one or more areas of conductive material configured to provide power to the small unmanned aircraft when not in flight.

16. A tether attachment apparatus for use in a tethered flight control system for a small unmanned aircraft having one or more rotors, the apparatus comprising:
a mounting portion configured to attach to a frame of the small unmanned aircraft;
a travel bar configured to have a tether line attach; and
two or more rotor protectors configured to prevent the tether line from striking the one or more rotors;
wherein the travel bar is mounted to the mounting portion such that the small unmanned aircraft has a full range of vertical and horizontal movement.

17. The apparatus as recited in claim 16, wherein the travel bar is triangular, and further comprises an upper portion and a lowest point;
wherein the lowest point is mounted close to the central axis of the small unmanned aircraft, allowing the tether line to guide the small unmanned aircraft directly in a vertical direction; and
wherein the upper portion is configured to align itself closest to the horizontal direction when the tether line is taut.

18. The apparatus as recited in claim 16, wherein the travel bar is curvilinear.

19. The apparatus as recited in claim 16, further comprising a support arm mounted between the one or more rotor protectors.

20. The apparatus as recited in claim 16, wherein the rotor protectors are shaped as quarter circles.
